(19) United States
(12) Patent Application Publication
(10) Pub. No.: US 2010/0029840 A1
(43) Pub. Date: Feb. 4, 2010

(54) WATER BASED INKJET RECORDING INK

(75) Inventor: Kiyoshi MORIMOTO, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/503,868

(22) Filed: Jul. 16, 2009

(30) Foreign Application Priority Data
Jul. 29, 2008 (JP) 2008-195232

(51) Int. Cl. C08L 33/10

(52) U.S. Cl. 524/558; 524/543; 524/560

(57) ABSTRACT

The present invention provides a water based inkjet recording ink including polyvinyl polymer particles and an aqueous medium, the polyvinyl polymer particles containing C.I. Pigment Yellow 155 and a polyvinyl polymer containing (a) a hydrophobic structural unit derived from at least one member selected from acrylates and methacrylates each having an aromatic ring bonded via a linking group to the main chain thereof and (b) a hydrophilic structural unit derived from acrylic acid and/or methacrylic acid and contained in an amount of 5% by mass to 18% by mass with respect to the total mass of the polymer. The water based inkj et recording ink, even after storage for a long period of time or storage under a high-temperature environment, is excellent in discharge stability and capable of preventing the generation of uneven density and streaked marks on the recorded image.

### CROSS-REFERENCE TO RELATED APPLICATION

This application claims priority under 35 USC 119 from Japanese Patent Application No. 2008-195232 filed on Jul. 29, 2008, the disclosure of which is incorporated by reference herein.

### BACKGROUND OF THE INVENTION

1. Field of the Invention

The present invention relates to a water based inkjet recording ink, which is suitable for recording ink images by an inkjet method.

2. Description of the Related Art

As recording media for inkjet recording, various media have been used in recent years, and there is a demand that not only paper for exclusive use in inkjet recording, but also commercially available plain paper and printing media such as high-quality paper, coated paper and art paper, be capable of recording high-quality images.

Even when plain paper or general printing media are used to record images, pigments are preferable as ink color materials providing fastness such as water-fastness and light-fastness, and so recording systems using aqueous pigment inks have been extensively studied from viewpoints including cost. As a yellow pigment for inkjet recording in such systems, C.I. Pigment Yellow 155, which is a dis-azo pigment, is preferably used by virtue of its high consealing power and excellent weather resistance.

As a water based inkjet recording ink, an aqueous dispersion for inkjet recording, which has an aqueous pigment dispersion containing C.I. Pigment Yellow 155 and a polymer dispersant, is disclosed (see, for example, US Patent Application Publication No. 2006-014855). Specifically, it is described therein that images excellent in light-fastness, ozone resistance and abrasion resistance can be formed by using C.I. Pigment Yellow 155 as the pigment and a copolymer consisting of 67% by weight of benzyl methacrylate and 33% by weight of methacrylic acid as the polymer dispersant.

### SUMMARY OF THE INVENTION

It is found that an ink constituted by using C.I. Pigment Yellow 155 or by using an aqueous pigment dispersion containing C.I. Pigment Yellow 155 together with a polymer dispersant as described above, when used after storage for a long period of time or in a high-temperature environment, generates uneven density or streaked marks easily on recorded images, thus failing to achieve satisfactory discharge accuracy. The present invention has been made in view of the above circumstances and provides a water based inkjet recording ink, which even after storage for a long period of time or in a high-temperature environment, is excellent in discharge stability and capable of preventing the generation of uneven density and streaked marks on the recorded image. More specifically, an aspect of the present invention provides a water based inkjet recording ink, including polyvinyl polymer particles and an aqueous medium, the polyvinyl polymer particles containing: a polyvinyl polymer containing (a) a hydrophobic structural unit derived from at least one member selected from acrylates and methacrylates each having an aromatic ring bonded via a linking group to the main chain thereof, and (b) a hydrophilic structural unit derived from acrylic acid and/or methacrylic acid and contained in an amount of 5% by mass to 18% by mass with respect to the total mass of the polymer, and C.I. Pigment Yellow 155.

### DETAILED DESCRIPTION OF THE INVENTION

The inventors found that colored particles are formed by using a polyvinyl polymer having a specific structure and C.I. Pigment Yellow 155, thereby enabling the ink after storage for a long period of time or in a high-temperature environment to be effectively prevented from reducing discharge accuracy upon discharge by an inkjet method, and the invention was made on the basis of this finding. The objects to solve the problems may be achieved by items <1> to <13> shown below.

<1> A water based inkjet recording ink including at least polyvinyl polymer particles and an aqueous medium, the polyvinyl polymer particles containing: a polyvinyl polymer containing (a) a hydrophobic structural unit derived from at least one member selected from acrylates and methacrylates each having an aromatic ring bonded via a linking group to the main chain thereof, and (b) a hydrophilic structural unit derived from acrylic acid and/or methacrylic acid and contained in an amount of 5% by mass to 18% by mass with respect to the total mass of the polymer; and C.I. Pigment Yellow 155.

<2> The water based inkjet recording ink of the item <1>, wherein the hydrophobic structural unit (a) is a structural unit represented by the following Formula (I):

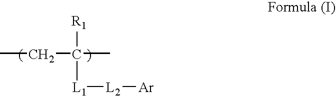

wherein in Formula (I), R₁ represents a hydrogen atom, a methyl group, or a halogen atom; L₁ represents *—COO—, *—OCO—, *—CONR₂—, *—O— or a substituted or unsubstituted phenylene group; L₂ represents a single bond or a divalent linking group having 1 to 30 carbon atoms; Ar represents a monovalent group derived from an aromatic ring; herein, R₂ represents a hydrogen atom or an alkyl group having 1 to 10 carbon atoms; and an asterisk (*) in the group represented by L₁ denotes a bond linking to the main chain.

<3> The water based inkjet recording ink of the item <2>, wherein, in Formula (I), R₁ represents a hydrogen atom or a methyl group; L₁ represents *—COO—; and L₂ represents a single bond or a divalent linking group having 1 to 25 carbon atoms and comprising an alkylene oxy group and/or an alkylene group.

<4> The water based inkjet recording ink of the item <1>, wherein a structural unit derived from phenoxyethyl(meth)acrylate and/or a structural unit derived from benzyl(meth)acrylate, in an amount of 20% by mass or more with respect to the total mass of the polyvinyl polymer, is contained as the hydrophobic structural unit (a).

<5> The water based inkjet recording ink of the item <1> or the item <4>, wherein a structural unit derived from phenoxyethyl(meth)acrylate, in an amount of 20% by mass or more with respect to the total mass of the polyvinyl polymer, is contained as the hydrophobic structural unit (a).

<6> The water based inkjet recording ink of any one of the items <1> to <5>, wherein the content ratio of the C.I. Pigment Yellow 155 to the polyvinyl polymer is 30% by mass to 60% by mass.

<7> The water based inkjet recording ink of any one of the items <1> to <6>, wherein the weight-average molecular weight of the polyvinyl polymer is 30,000 to 80,000.

<8> The water based inkjet recording ink of any one of the items <1> to <7>, which further comprises self-dispersible polymer particles.

<9> The water based inkjet recording ink of the item <8>, wherein the self-dispersible polymer particles have a carboxy group.

<10> The water based inkjet recording ink of the item <8> or the item <9>, wherein the self-dispersible polymer particles are particles of a polymer comprising a structural unit derived from an aromatic group-containing (meth)acrylate, in an amount of 15% by mass to 80% by mass with respect to the total mass of the self-dispersible polymer particles, and a structural unit derived from an alkyl group-containing monomer.

<11> The water based inkjet recording ink of the item <10>, wherein the aromatic group-containing (meth)acrylate is phenoxyethyl(meth)acrylate and/or benzyl(meth)acrylate.

<12> The water based inkjet recording ink of the item <10> or the item <11>, wherein the alkyl group-containing monomer is an alkyl(meth)acrylate in which the alkyl moiety has 1 to 4 carbon atoms.

<13> The water based inkjet recording ink of any one of the items <1> to <12>, which further comprises a surfactant.

Hereinafter, the water based inkjet recording ink of the invention will be described in detail.

### <<Water Based Inkjet Recording Ink>>

The water based inkjet recording ink of the invention contains at least: at least one of polyvinyl polymer particles containing a polyvinyl polymer and C.I. Pigment Yellow 155, and at least one aqueous medium, wherein the polyvinyl polymer (also referred to hereinafter as “the polyvinyl polymer in the invention”) contains (a) a hydrophobic structural unit derived from at least one member selected from an acrylate having an aromatic ring bonded via a linking group to the main chain thereof and a methacrylate having an aromatic ring bonded via a linking group to the main chain thereof, and (b) a hydrophilic structural unit derived from acrylic acid and/or methacrylic acid and contained in an amount of 5% by mass to 18% by mass with respect to the total mass of the polymer.

If necessary, other components such as a surfactant can also be used to constitute the water based inkjet recording ink of the invention.

(Polyvinyl Polymer Particles)

The polyvinyl polymer particles in the invention are colored particles (polyvinyl polymer particles) containing at least a polyvinyl polymer and C.I. Pigment Yellow 155 wherein C.I. Pigment Yellow 155 is covered at least partially thereon with the polyvinyl polymer, and an aqueous dispersion of the colored particles dispersed in water can be used. This aqueous dispersion of polyvinyl polymer particles generally contains water and can contain not only C.I. Pigment Yellow 155 but also other pigments as the color material. The aqueous dispersion of polyvinyl polymer particles can be constituted by further using other components such as organic solvents or color materials including dyes other than the pigment.

—Polyvinyl Polymer—

The polyvinyl polymer in the invention is constituted of a structure having at least one of hydrophobic structural unit (a) and at least one of hydrophilic structural unit (b) and may be constituted if necessary by further having other structural units different from the hydrophobic structural unit (a) and the hydrophilic structural unit (b).

<Hydrophobic Structural Unit (a)>

The polyvinyl polymer in the invention contains at least (a) a hydrophobic structural unit derived from at least one member selected from an acrylate having an aromatic ring bonded via a linking group to the main chain thereof and a methacrylate having an aromatic ring bonded via a linking group to the main chain thereof. The polyvinyl polymer has a structure in which the aromatic ring is bonded via a linking group to an atom of the main chain of the polymer and is thus not directly bonded to the atom of the main chain, thereby maintaining a suitable distance between the hydrophobic aromatic ring and the hydrophilic structural unit acrylate or methacrylate, thus easily generating interaction between the polyvinyl polymer and the pigment, to achieve strong adsorption to further improve dispersibility.

The content ratio of the hydrophobic structural units (a) is preferably in a range of 10% by mass or more but less than 75% by mass, more preferably in a range of 20% by mass or more but less than 70% by mass, and particularly preferably in a range of 30% by mass or more but less than 60% by mass with respect to total mass of the polyvinyl polymer, from viewpoints of dispersion stability of the pigment, discharge stability, and detergency.

In the invention, the “(a) hydrophobic structural unit containing an aromatic ring” is preferably introduced in the polyvinyl polymers in a form of a structural unit represented by the following Formula (I):

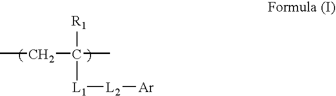

In Formula (I), R₁ represents a hydrogen atom, a methyl group, or a halogen atom. L₁ represents *—COO—, *—OCO—, *—CONR₂—, *—O—, or a substituted or unsubstituted phenylene group, and R₂ represents a hydrogen atom or an alkyl group having 1 to 10 carbon atoms. In the group represented by L₁, an asterisk (*) denotes a bond linking to the main chain. The substituent of the phenylene group is not particularly limited, and examples thereof include a halogen atom, an alkyl group, an alkoxy group, a hydroxy group, and a cyano group.

L₂ represents a single bond or a divalent linking group having 1 to 30 carbon atoms. When L₂ is a divalent linking group, it is preferably a linking group having 1 to 25 carbon atoms, more preferably a linking group having 1 to 20 carbon atoms, and even more preferably a linking group having 1 to 15 carbon atoms.

Among them, particularly preferable examples include an alkyleneoxy group having 1 to 25 (more preferably 1 to 10) carbon atoms, an imino group (—NH—), a sulfamoyl group, and divalent linking groups containing an alkylene group and/or alkylene oxy group, such as an alkylene group having 1 to 20 (more preferably 1 to 15) carbon atoms or an ethylene oxide group [—(CH₂CH₂O)ₙ—, n (which means an average repeat number)=1 to 6], and combinations of two or more of these groups.

In Formula (I), Ar represents a monovalent group derived from an aromatic ring.

The aromatic ring represented by Ar is not particularly limited, and examples thereof include a benzene ring, a condensed aromatic ring having eight or more carbon atoms, an aromatic ring condensed with a heterocycle, and two or more benzene rings linked to each other.

The “condensed aromatic ring having eight or more carbon atoms” refers to a condensed aromatic ring having at least two benzene rings, or an aromatic compound having eight or more carbon atoms including at least one aromatic ring and an alicyclic hydrocarbon condensed with the aromatic ring. Specific examples include naphthalene, anthracene, fluorene, phenanthrene, and acenaphthene.

The “aromatic ring condensed with a heterocycle” refers to a compound obtained by condensation between an aromatic compound (preferably a benzene ring) containing no heteroatom, and a cyclic compound containing a heteroatom. The heteroatom-containing cyclic compound is preferably a five-membered or six-membered ring. The heteroatom is preferably a nitrogen atom, an oxygen atom, or a sulfur atom. The heteroatom-containing cyclic compound may contain plural heteroatoms. In this case, the heteroatoms may be the same or different from each other. Specific examples of the aromatic ring condensed with a heterocycle include phthalimide, acridone, carbazole, benzoxazole, and benzothiazole.

Among the structural units represented by Formula (I), structural units wherein R₁ represents a hydrogen atom or a methyl group, L₁ represents *—COO—, and L₂ represents divalent linking groups containing an alkylene group and/or alkylene oxy group having 1 to 25 carbon atoms are preferable; and structural units wherein R₁ represents a hydrogen atom or a methyl group, L₁ represents *—COO—, and L₂ represents an ethylene oxide group [*—(CH₂CH₂O)ₙ—, n (which means an average repeat number)=1 to 6, an asterisk (*) denotes a bond linking to the main chain] are more preferable.

Specific examples of the monomer for forming the hydrophobic structural unit (a) are shown below. However, the invention is not limited to the following specific examples.

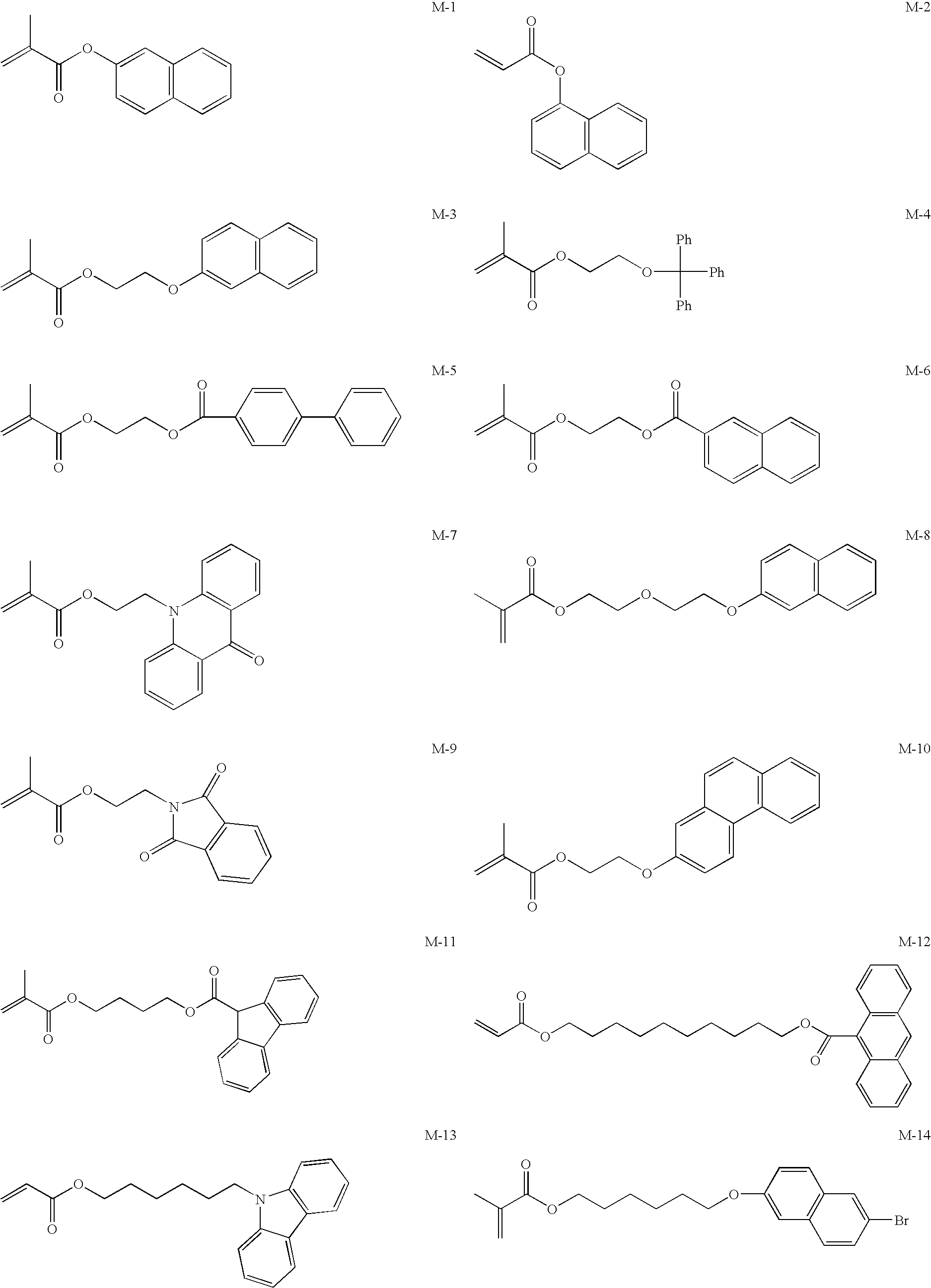

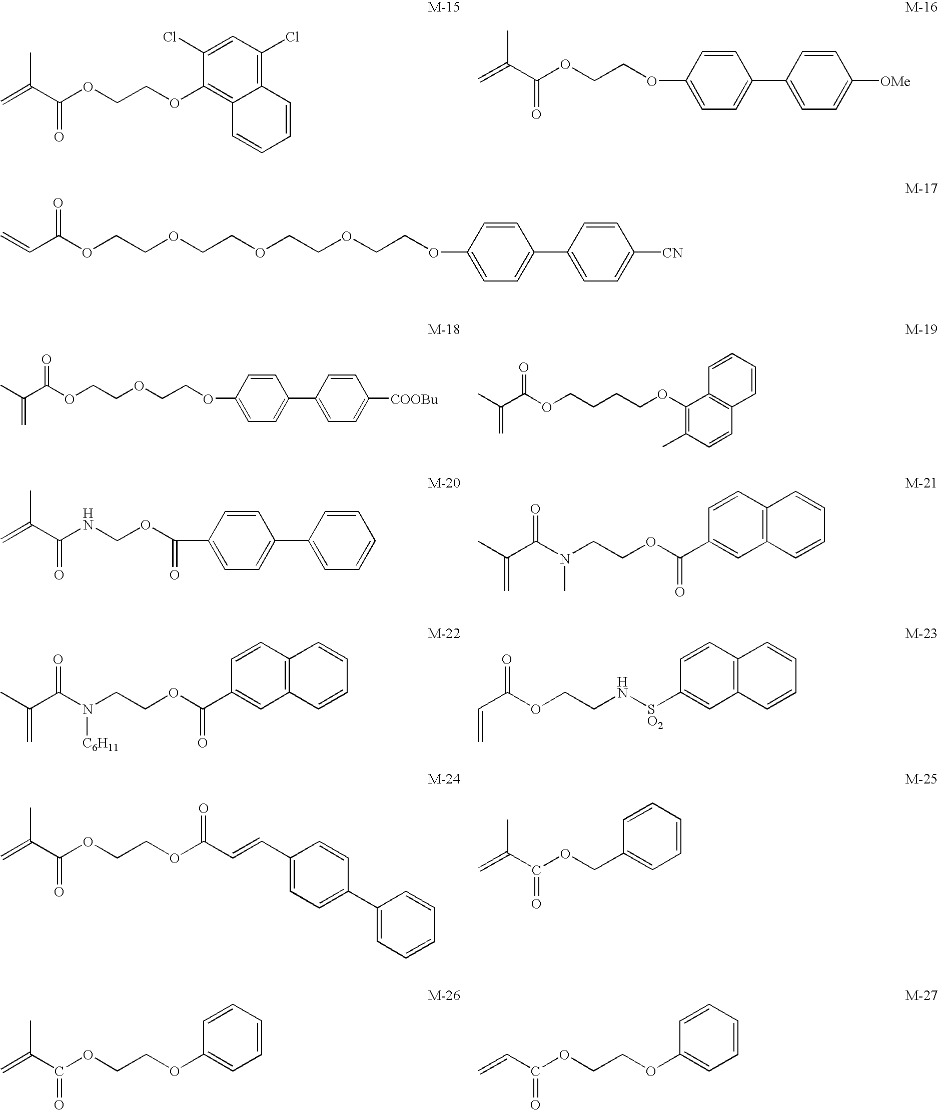

Among the hydrophobic structural units (a) forming the polyvinyl polymers in the invention, one or more structural units derived from anyone of a benzyl acrylate, a benzyl methacrylate, a phenoxyethyl acrylate or a phenoxyethyl methacrylate, are preferable from the viewpoint of dispersion stability.

<Other Hydrophobic Structural Unit (a1)>

The polyvinyl polymer in the invention may further have a hydrophobic structural unit (a1) other than the hydrophobic structural unit (a) [preferably a hydrophobic structural unit represented by Formula (1)]. The other hydrophobic structural unit (a1) includes structural units derived from, for example, vinyl monomers such as (meth)acrylates, (meth)acrylamides, styrenes, and vinyl esters which do not belong to the hydrophilic structural units (b) (e.g., not having a hydrophilic functional group) described below. These structural units may be used alone or in a combination of two or more of them.

Preferable examples of the other hydrophobic structural unit (a1) include an alkyl acrylate and alkyl methacrylate in which the alkyl moiety has 1 to 18 carbon atoms. The alkyl moiety in this alkyl ester has preferably 1 to 8 carbon atoms, more preferably 1 to 4 carbon atoms, and even more preferably 1 or 2 carbon atoms, from the viewpoint that the aromatic ring and the pigment when interacting with each other are not sterically adversely affected.

A content ratio of the other hydrophobic structural units (a1) in the polyvinyl polymer is preferably from 5% by mass to 70% by mass, and more preferably 20% by mass to 60% by mass with respect to total mass of the polyvinyl polymer, from the viewpoint of enlarging interaction between the aromatic ring in the polymer and the pigments.

Examples of the (meth)acrylates include methyl(meth)acrylate, ethyl(meth)acrylate, iso-propyl(meth)acrylate, iso-butyl(meth)acrylate, t-butyl(meth)acrylate, cyclohexyl(meth)acrylate, dodecyl(meth)acrylate, and stearyl(meth)acrylate. Among them, methyl(meth)acrylate, ethyl(meth)acrylate and cyclohexyl(meth)acrylate are preferable as the (meth)acrylates

Examples of the (meth)acrylamides include N-cyclohexyl(meth)acrylamide, N-2-methoxyethyl(meth)acrylamide, N,N-diallyl(meth)acrylamide, and N-allyl(meth)acrylamide.

Examples of the styrenes include styrene, methylstyrene, dimethylstyrene, trimethylstyrene, ethylstyrene, isopropylstyrene, n-butylstyrene, tert-butylstyrene, methoxystyrene, butoxystyrene, acetoxystyrene, chlorostyrene, dichlorostyrene, bromostyrene, chloromethylstyrene, methyl vinylbenzoate, α-methylstyrene, and vinylnaphthalene. Among them, styrene or α-methylstyrene is preferable.

Examples of the vinyl esters include vinyl acetate, vinyl chloroacetate, vinyl propionate, vinyl butyrate, vinyl methoxy acetate, and vinyl benzoate. Among them, vinyl acetate is preferable.

<Hydrophilic Structural Unit (b)>

The polyvinyl polymer in the invention contains at least a hydrophilic structural unit (b) derived from acrylic acid and/or methacrylic acid.

The content ratio of the hydrophilic structural unit (b) is in a range of from 5% by mass to 18% by mass with respect to the total mass of the polyvinyl polymer, from the viewpoints of the dispersion stability of the pigment, discharge stability, and detergency. When the content ratio of the hydrophilic structural unit (b) is less than 5% by mass, dispersion stability is deteriorated, and when the content ratio is more than 18% by mass, the amount of the component dissolved in an aqueous medium by itself is increased, so that various properties such as pigment dispersibility are deteriorated and the ability of ink to be ejected in inkjet recording is deteriorated.

The content ratio of the hydrophilic structural unit (b) is particularly preferably in a range of from 7% by mass to 15% by mass.

<Other Hydrophilic Structural Unit (b1)>

The polyvinyl polymer contains not only a structural unit derived from acrylic acid and/or a structural unit derived from methacrylic acid as the hydrophilic structural unit (b) but also a structural unit derived from a nonionic hydrophilic group-containing monomer as another hydrophilic structural unit (b1). The structural unit derived from a nonionic hydrophilic group-containing monomer includes, for example, hydrophilic functional group-containing vinyl monomers such as hydrophilic functional group-containing (meth)acrylates, (meth)acrylamides and vinyl esters.

Examples of the “hydrophilic functional group” include a hydroxy group, an amino group, an amido group (having an unsubstituted nitrogen atom), and the below-described alkylene oxides such as polyethylene oxide and polypropylene oxide.

The hydrophilic structural unit containing a nonionic hydrophilic group includes preferably a hydrophilic structural unit having a hydroxy group. A number of the hydroxy group in the hydrophilic structural unit is not particularly limited. The number of the hydroxy group in the hydrophilic structural unit is preferably from 1 to 4, more preferably from 1 to 3, and particularly preferably 1 or 2, from the viewpoints of hydrophilicity of the polyvinyl polymer and compatibility with solvent(s) or other monomer(s) in polymerization.

The hydrophilic structural unit containing a nonionic hydrophilic group includes preferably a hydrophilic structural unit having an alkylene oxide structure. From the viewpoint of hydrophilicity, the alkylene moiety in the alkylene oxide structure is preferably an alkylene moiety having 1 to 6 carbon atoms, more preferably an alkylene moiety having 2 to 6 carbon atoms, and particularly preferably an alkylene moiety having 2 to 4 carbon atoms. The degree of polymerization of the alkylene oxide structure is preferably from 1 to 120, more preferably from 1 to 60, and particularly preferably from 1 to 30.

The monomer for forming the hydrophilic structural unit containing a nonionic hydrophilic group is not particularly limited as long as it contains a functional group for forming a polymer, such as an ethylenically unsaturated bond, and a nonionic hydrophilic functional group. The monomer may be selected from known monomers. Specific examples of preferable monomers may include hydroxyethyl(meth)acrylate, hydroxybutyl(meth)acrylate, (meth)acrylamide, aminoethyl acrylate, aminopropyl acrylate, and (meth)acrylates containing an alkylene oxide polymer.

The hydrophilic structural units containing a nonionic hydrophilic group may be formed through polymerization of corresponding monomers, or introduction of a hydrophilic functional group to the polymer chain after polymerization.

In the above, for example, the content ratio of the hydrophilic structural units (b) depends on the content ratio of the above-described hydrophobic structural units (a). For example, when the polyvinyl polymer consists of acrylic acid and/or methacrylic acid [hydrophilic structural units (b)] and the hydrophobic structural units (a), the content ratio of the acrylic acid and/or methacrylic acid is calculated by “100−(mass percentage of hydrophobic structural units(a))”.

The hydrophilic structural units (b) may be used alone or in a combination of two or more of them.

The polyvinyl polymer in the invention may be either a random copolymer having the structural units introduced irregularly thereto or a block copolymer having the structural units regularly introduced thereto, and the block copolymer may be synthesized by introducing the structural units in any order or by using the same constituent component twice or more, but the random copolymer is preferable from the viewpoints of versatility and productivity.

The molecular weight of the polyvinyl polymer in the invention, in terms of weight-average molecular weight (Mw), is preferably in the range of 30,000 to 150,000, more preferably 30,000 to 100,000, and even more preferably 30,000 to 80,000. The weight-average molecular weight in this range is preferable from the standpoint that the polyvinyl polymer tends to be excellent in steric repulsion effect as a dispersant and tends to be adsorbed onto the pigment in a short time by its steric effect.

The molecular-weight distribution of the polyvinyl polymer (expressed as weight-average molecular weight/number-average molecular weight) is preferably in the range of 1 to 6, and more preferably in the range of 1 to 4. The molecular-weight distribution in this range is preferable from the dispersion stability and discharge stability of ink.

The number-average molecular weight and the weight-average molecular weight are measured by the differential refractometer detection with THF as a solvent in a GPC analyzer using columns TSKgel GMHxL, TSKgel G4000 HxL and TSKgel G2000 HxL (trade name all manufactured by Tosoh Corporation), and is obtained by conversion with a polystyrene reference material.

The polyvinyl polymers in the invention may be synthesized by any polymerization method, for example, solution polymerization, precipitation polymerization, suspension polymerization, bulk polymerization, or emulsion polymerization. The polymerization reaction may be carried out under a known system, such as a batch, semi-continuous, or continuous system. Initiation of the polymerization may be carried out with a radical initiator, or photoirradiation or radiation-irradiation. These methods of polymerization and initiation of polymerization are described in, for example, “Kobunshi Gosei Hoho” by Teiji Turuta, Revised Edition (published by Nikkan Kogyo Shimbun, Ltd., 1971) and “Kobunshi Gosei no Jikkenho” by Takayuki Ohtu and Masaetu Kinoshita (published by Kagaku-Dojin Publishing Company Inc., 1972) pp. 124 to 154.

Among these polymerization methods, a solution polymerization method using a radical initiator is preferable. Examples of the solvent used in the solution polymerization method include various organic solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, and 1-butanol. These solvents may be used alone or in a mixture of two or more of them, or may be mixed with water as a mixed solution. The polymerization temperature should be chosen in consideration of the molecular weight of the intended polymer and the type of the initiator, and is usually from 0° C. to 100° C., and is preferably from 50° C. to 100° C. The reaction pressure may be appropriately selected, and is usually from 1 kg/cm² to 100 kg/cm², and particularly preferably from about 1 kg/cm² to 30 kg/cm². The reaction period may be about 5 hours to about 30 hours. The resultant resin may be subjected to purification treatment such as reprecipitation.

The polyvinyl polymer particles in the invention are resin-coated pigment particles consisting of Pigment Yellow 155 particles covered at least partially or wholly thereon with the above polyvinyl polymer and can be used preferably as an aqueous dispersion of this resin-coated pigment dispersed in water.

The water based inkjet recording ink of the invention can be prepared by using an aqueous dispersion prepared from the polyvinyl polymer particles in the invention.

For example, the particles of the polyvinyl polymer in the invention may be produced from a water-insoluble polyvinyl polymer and a pigment by a known physical or chemical method such as that described in JP-A Nos. 9-151342, 10-140065, 11-209672, 11-172180, 10-25440, and 11-43636. Specific examples of the method include the phase inversion method and acid precipitation method described in JP-A Nos. 9-151342 and 10-140065. Among these methods, the phase inversion method is preferable from the viewpoint of dispersion stability.

a) Phase Inversion Method

Basically, the phase inversion method is a self dispersion (phase inversion emulsification) method comprising dispersing in water a mixed melt of a pigment and a resin having self-dispersibility or solubility. The mixed melt may contain a curing agent or a polymer compound. The mixed melt refers to a state where undissolved components are mixed and/or a state where dissolved components are mixed. Details about the “phase inversion method” are described in JP-A No. 10-140065.

b) Acid Precipitation Method

The acid precipitation method is a method for producing a microcapsulated pigment, including steps of preparing a hydrous cake of a resin and a pigment, and neutralizing part or all of the anionic groups of the resin in the hydrous cake using a basic compound.

The acid precipitation method specifically includes steps of: (1) dispersing a resin and a pigment in an alkaline aqueous medium, and, if necessary, heating the dispersion for gelation of the resin; (2) adjusting the pH to a neutral or acidic value thereby hydrophobizing the resin to strongly attaching the resin to the pigment; (3) at need, carrying out filtration and water washing to obtain a hydrous cake; (4) neutralizing part or all of the anionic groups of the resin in the hydrous cake using a basic compound, and then re-dispersing it in an aqueous medium; and (5) at need, heating the dispersion for gelation of the resin.

The phase inversion method and acid precipitation method are detailed in JP-A Nos. 9-151342 and 10-140065.

In the water based inkjet recording ink of the invention, the polyvinyl polymer particles may be prepared by a method including steps (1) and (2) below, which is provided with a step of preparing a dispersion of polyvinyl polymer particles in which the polyvinyl polymer in the invention (preferably the polyvinyl polymer containing the structural unit represented by Formula (I)) is used. The water based inkjet recording ink of the present invention may be prepared by a method of forming a dispersion of the polyvinyl polymer particles obtained at the step of preparing it into a water based ink with water and an organic solvent.

Step (I): dispersing a mixture containing the polyvinyl polymer containing (a) a hydrophobic structural unit derived from at least one member selected from acrylates and methacrylates each having an aromatic ring bonded via a linking group to the main chain thereof and (b) a hydrophilic structural unit derived from acrylic acid and/or methacrylic acid and contained in an amount of 5% by mass to 18% by mass with respect to the total mass of the polymer, an organic solvent, a neutralizing agent, a pigment, and water under stirring etc. to yield a dispersion.

Step (2): Removing the Organic Solvent from the Dispersion.

The stirring method is not particularly limited, and may use a common mixing stirrer or, if necessary, a disperser such as an ultrasonic disperser, a high-pressure homogenizer, or a bead mill.

Examples of the organic solvents preferably used herein include alcohol solvents, ketone solvents, and ether solvents. Examples of the alcohol solvents include isopropyl alcohol, n-butanol, t-butanol, and ethanol. Examples of the ketone solvents include acetone, methyl ethyl ketone, diethyl ketone, and methyl isobutyl ketone. Examples of the ether solvents include dibutyl ether and dioxane. Among these solvents, ketone solvents such as methyl ethyl ketone and alcohol solvents such as isopropyl alcohol are preferable, and methyl ethyl ketone is even more preferable.

The neutralizing agent is used for forming an emulsified or dispersed state wherein part or all of the dissociative groups such as carboxy groups is neutralized, and the polyvinyl polymer is stable in water. Details about the neutralizing agent will be described later in an item of self-dispersible polymer particles.

In the step (2), the organic solvent is evaporated from the dispersion prepared in the step (1) by a common procedure such as vacuum distillation to convert the phase into a water system, thereby obtaining a dispersion of resin-coated pigment particles, the particle surface of the pigment being coated with the polyvinyl polymer. The obtained dispersion is substantially free of the organic solvent. The amount of the organic solvent is preferably 0.2% by mass or less, and more preferably 0.1% by mass or less.

More specifically, for example, the above-described method includes steps of: (1) mixing an anionic group (such as carboxy group)-containing polyvinyl polymer or its solution in an organic solvent with a base compound (neutralizing agent) thereby carrying out neutralization; (2) mixing the obtained mixed solution with a pigment to make a suspension, and then dispersing the pigment with a disperser or the like to obtain a pigment dispersion; and (3) removing the organic solvent by, for example, distillation thereby coating the pigment with the anionic group-containing polyvinyl polymer, and dispersing the coated pigment particles in an aqueous medium to make an aqueous dispersion.

The Method is Further Detailed in JP-A Nos. 11-209672 and 11-172180.

In the invention, the dispersion treatment may be carried out using, for example, a ball mill, a roll mill, a bead mill, a high-pressure homogenizer, a high-speed stirring disperser, or an ultrasonic homogenizer.

A content ratio of the polyvinyl polymer in the polyvinyl polymer particle is preferably from 10% by mass to 100% by mass, more preferably from 20% by mass to 60%by mass, and even more preferably from 25% by mass to 50% by mass with respect to a mass of the pigment (including C. I. Pigment Yellow 155), from the viewpoint of dispersion stability.

—C.I. Pigment Yellow 155—

The polyvinyl polymer particles in the invention contain Pigment Yellow 155 as a pigment and may further contain other pigments, dyes etc. for the purpose of hue regulation etc.

When Pigment Yellow 155 is used in combination with other pigments, the ratio (Pg¹: Pg²) of the amount of Pigment Yellow 155 (Pg¹) to the amount of other pigments (Pg²) is preferably 10:90 to 90:10, from the viewpoint of preventing deterioration in the effect of the invention.

Other pigments are not particularly limited, can be selected appropriately depending on the purpose, and may be organic pigments or inorganic pigments.

The organic pigments include, for example, azo pigments, polycyclic pigments, dye chelates, nitro pigments, nitroso pigments, aniline black, etc. Among them, azo pigments and polycyclic pigments are preferable. The azo pigments include, for example, azo lakes, insoluble azo pigments, condensed azo pigments, chelate azo pigments, etc. The polycyclic pigments include, for example, phthalocyanine pigments, perylene pigments, perynone pigments, anthraquinone pigments, quinacridone pigments, dioxazine pigments, indigo pigments, thioindigo pigments, isoindolinone pigments, quinophthalone pigments, etc. The dye chelates include, for example, basic dye chelates, acidic dye chelates, etc.

The inorganic pigments include, for example, titanium oxide, iron oxide, calcium carbonate, barium sulfate, aluminum hydroxide, barium yellow, cadmium red, chromium yellow, and carbon black. Among them, carbon black is particularly preferable.

From the viewpoints of color density and discharge stability, the content of the polyvinyl polymer particles in the water based inkjet recording ink in the invention is preferably 0.1% by mass to 10% by mass, and more preferably 1% by mass to 4% by mass, with respect to the total mass of the water based inkjet recording ink.

(Water-Soluble Solvent)

The water based inkjet recording ink of the invention contains at least one aqueous medium and preferably contains at least one water-soluble organic solvent as an essential component. The water-soluble organic solvent brings about an effect of drying prevention, moistening or penetration promotion. For dying prevention, the water-soluble organic solvent is used as a drying inhibitor which prevents the ink from being adhered and dried in an ink discharge opening of a spray nozzle thereby preventing forming aggregates and clogging in the opening. For drying prevention and moistening, a water-soluble organic solvent having a vapor pressure lower than that of water is preferably used. For penetration promotion, the water-soluble organic solvent can be used as a penetration promoting agent for promoting penetration of ink into paper.

Examples of the water-soluble organic solvents include alkanediols (polyhydric alcohols) such as glycerin, 1,2,6-hexanetriol, trimethylolpropane, ethylene glycol, propylene glycol, diethylene glycol, triethylene glycol, tetraethylene glycol, pentaethylene glycol, dipropylene glycol, polyoxyethylene glyceryl ether, polyoxypropylene glyceryl ether, 2-butene-1,4-diol, 2-ethyl-1,3-hexanediol, 2-methyl-2,4-pentanediol, 1,2-octanediol, 1,2-hexanediol, 1,2-pentanediol, and 4-methyl-1,2-pentanediol; saccharides such as glucose, mannose, fructose, ribose, xylose, arabinose, galactose, aldonic acid, glucitol, solbitol, maltose, cellobiose, lactose, sucrose, trehalose, and maltotriose; glycitols; hyaluronic acids; so-called solid humectants such as ureas; alkyl alcohols having 1 to 4 carbon atoms, such as ethanol, methanol, butanol, propanol, and isopropanol; glycol ethers such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, and dipropylene glycol mono-iso-propyl ether; 2-pyrrolidone, N-methyl-2-pyrrolidone, 1,3-dimethyl-2-imidazolidinone, formamide, acetamide, dimethyl sulfoxide, sorbit, sorbitan, acetin, diacetin, triacetin, and sulfolane. These organic solvents may be used alone or in a combination of two or more of them.

As an anti-drying agent or a humectant, polyhydric alcohols are useful. Examples of the polyhydric alcohols include glycerin, ethylene glycol, diethylene glycol, triethylene glycol, propylene glycol, dipropylene glycol, tripropylene glycol, 1,3-butanediol, 2,3-butanediol, 1,4-butanediol, 3-methyl-1,3-butanediol, 1,5-pentanediol, tetraethylene glycol, 1,6-hexanediol, 2-methyl-2,4-pentanediol, polyethylene glycol, 1,2,4-butanetriol, and 1,2,6-hexanetriol. These polyhydric alcohols may be used alone or in combination of two or more of them.

As a penetration promoting agent, polyhydric alcohols are preferable. Examples of aliphatic diols include 2-ethyl-2-methyl-1,3-propanediol, 3,3-dimethyl-1,2-butanediol, 2,2-diethyl-1,3-propanediol, 2-methyl-2-propyl-1,3-propanediol, 2,4-dimethyl-2,4-pentanediol, 2,5-dimethyl-2,5-hexanediol, 5-hexene-1,2-diol, and 2-ethyl-1,3-hexanediol. Among them, 2-ethyl-1,3-hexanediol and 2,2,4-trimethyl-1,3-pentanediol are preferable. These polyhydric alcohols may be used alone or in a combination of two or more of them.

Among above, preferable examples as the water-soluble organic solvent include glycerin, dipropylene glycol, polyoxyethylene glyceryl ether, and polyoxypropylene glyceryl ether.

A content of the water soluble organic solvent in the aqueous medium is preferably from 5% by mass to 60% by mass, and more preferably from 10% by mass to 40% by mass.

The water based inkj et recording ink in the invention may contain water with or without the water-soluble organic solvent as the aqueous medium.

When the water based inkjet recording ink contains water, the content of water is preferably from 10% by mass to 99% by mass, more preferably from 30% by mass to 80% by mass, and even more preferably from 50% by mass to 70% by mass, although the content of water is not particularly limited.

The water based inkj et recording ink in the invention may contain, in addition to the above described components, if necessary, other components such as a surfactant, resin particles or a ultraviolet absorbent.

—Resin Particles—

The water based inkjet recording ink in the invention may contain resin particles. Examples of the resin particles include fine particles of acrylic resins, vinyl acetate resins, styrene-butadiene resins, vinyl chloride resins, acryl-styrene resins, butadiene resins, styrenic resins, crosslinked acrylic resins, crosslinked styrenic resins, benzoguanamine resins, phenolic resins, silicone resins, epoxy resins, urethane resins, paraffin resins, and fluorine resins. These resins may be used in the form of polymer latexes including these resins.

Among the above resins, acrylic resins, acryl-styrene resins, styrenic resins, crosslinked acrylic resins, and crosslinked styrenic resins are preferable.

From the viewpoints of discharge stability and liquid stability (particularly dispersion stability), the resin particles are preferably self-dispersible polymer particles, and more preferably self-dispersible particles having a carboxy group. The self-dispersible polymer particles refer to water-insoluble polymer particles which do not contain a free emulsifier and are made of a water-insoluble polymer that can, in the absence of a surfactant, be in a dispersed state in an aqueous medium by functional groups (particularly acidic groups or salts thereof) possessed by the polymer itself.

As used herein, the “dispersed state” includes both an emulsified state (emulsion) in which the water-insoluble polymer is dispersed in a liquid state in an aqueous medium and a dispersed state (suspension) in which the water-insoluble polymer is dispersed in a solid state in an aqueous medium.

The water-insoluble polymer in the invention is preferably a water-insoluble polymer that can be in a dispersed state of the water-insoluble polymer dispersed in a solid state, from the viewpoints of the aggregation rate and fixability thereof upon conversion into a liquid composition.

The dispersed state of the self-dispersible polymer particles in the invention refers to the state of the water-insoluble polymer that can be visually confirmed to be stable in a dispersed state at 25° C. for at least 1 week. The dispersion is prepared as follows: a solution wherein 30 g of the water-insoluble polymer is dissolved in 70 g of an organic solvent (for example, methyl ethyl ketone), a neutralizing agent capable of neutralizing 100% of salt-forming groups of the water-insoluble polymer (the neutralizing agent is sodium hydroxide when the salt-forming groups are anionic, or acetic acid when the salt-forming groups are cationic), and 200 g of water are mixed and stirred (apparatus: a stirring apparatus equipped with stirring blades, a number of revolutions of 200 rpm, 30 minutes, 25° C.), and then the organic solvent is removed from the mixture.

The water-insoluble polymer refers to a polymer which after drying at 105° C. for 2 hours, is dissolved in an amount of 10 g or less in 100 g water at 25° C., and the amount of the water-insoluble polymer dissolved is preferably 5 g or less, and more preferably 1 g or less. The amount of the water-insoluble polymer dissolved is the amount of the polymer dissolved when neutralized to a degree of 100% with sodium hydroxide or acetic acid depending on the type of the salt-forming groups of the water-insoluble polymer.

The aqueous medium used herein is constituted by containing water and may contain, if necessary, a hydrophilic organic solvent. In the invention, the aqueous medium is constituted preferably of water and a hydrophilic organic solvent in an amount of 0.2% by mass or less with respect to the water, and constituted more preferably of water.

From the viewpoint of self-dispersibility, the water based inkjet recording ink of the invention preferably contains, as self-dispersible polymer particles, a water-insoluble polymer containing a hydrophilic structural unit and a structural unit derived from an aromatic group-containing monomer.

The hydrophilic structural unit is not particularly limited as long as it is derived from a hydrophilic group-containing monomer. The hydrophilic structural unit may contain one structural unit derived from a hydrophilic group-containing monomer or two or more structural units derived from hydrophilic group-containing monomer.

The hydrophilic group of the hydrophilic group-containing monomer is not particularly limited, and may be either a dissociable group or a nonionic hydrophilic group. The hydrophilic group is preferably a dissociable group, and more preferably an anionic dissociable group, from the viewpoint of acceleration of self-dispersion and from the viewpoint of the stability of the formed emulsified or dispersed state. The dissociable group includes a carboxy group, a phosphate group and a sulfonate group, among which a carboxy group is preferable from the viewpoint of fixability of the resultant water based inkjet recording ink.

From the viewpoints of self-dispersibility and aggregation property, the hydrophilic group-containing monomer is preferably a dissociable group-containing monomer, which is preferably a dissociable group-containing monomer having a dissociable group and an ethylenically unsaturated bond.

The dissociable group-containing monomer includes, for example, an unsaturated carboxylic acid monomer, an unsaturated sulfonic acid monomer, an unsaturated phosphoric acid monomer.

Examples of the unsaturated carboxylic acid monomer include acrylic acid, methacrylic acid, crotonic acid, itaconic acid, maleic acid, fumaric acid, citraconic acid, 2-methacryloyloxymethylsuccinic acid.

Examples of the unsaturated sulfonic acid monomer include styrenesulfonic acid, 2-acrylamido-2-methylpropanesulfonic acid, 3-sulfopropyl(meth)acrylate, bis-(3-sulfopropyl)-itaconic acid ester.

Examples of the unsaturated phosphoric acid monomer include vinylphosphonic acid, vinyl phosphate, bis(methacryloxyethyl)phosphate, diphenyl-2-acryloyloxyethyl phosphate, diphenyl-2-methacryloyloxyethyl phosphate, dibutyl-2-acryloyloxyethyl phosphate.

Among the dissociable group-containing monomers described above, unsaturated carboxylic acid monomers are preferable, and acrylic acid and methacrylic acid are more preferable, from the viewpoints of dispersion stability and discharge stability.

The aromatic group-containing monomer forming a structural unit of the water-insoluble polymer is not particularly limited as long as it is a compound containing an aromatic group and a polymerizable group.

The aromatic group may be a group derived from an aromatic hydrocarbon or a group derived from an aromatic heterocycle. From the viewpoint of the shape stability of particles in an aqueous medium, the aromatic group is preferably an aromatic group derived from an aromatic hydrocarbon.

The polymerizable group may be a condensation-polymerizable group or an addition-polymerizable group. From the viewpoint of the shape stability of particles in an aqueous medium, the polymerizable group in the invention is preferably an addition-polymerizable group, and more preferably an ethylenically unsaturated bond-containing group.

The aromatic group-containing monomer is preferably a monomer having an aromatic hydrocarbon-derived aromatic group and an ethylenically unsaturated bond, and more preferably an aromatic group-containing (meth)acrylate. Preferable examples of the aromatic group-containing monomer include phenoxyethyl(meth)acrylate, benzyl(meth)acrylate, phenyl(meth)acrylate, a styrene-based monomer. From the viewpoints of ink fixability and the balance between the hydrophilicity and hydrophobicity of the polymer chain, the aromatic group-containing monomer is preferably at least one member selected from phenoxyethyl(meth)acrylate, benzyl(meth)acrylate and phenyl(meth)acrylate, more preferably phenoxyethyl(meth)acrylate, and even more preferably phenoxyethyl acrylate.

The “(meth)acrylate” means acrylate or methacrylate.

The self-dispersible polymer particles are preferably particles of polymer containing a structural unit derived from an aromatic group-containing (meth)acrylate in an amount of 10% by mass to ⁹⁵% by mass. When the content of the structural unit derived from an aromatic group-containing (meth)acrylate is 10% by mass to 95% by mass, the stability of a self-emulsified or self- dispersed state can be improved to prevent an increase in viscosity.

From the viewpoints of the stability of self-dispersed state, the shape stabilization of particles in an aqueous medium by the hydrophobic interaction among aromatic rings, and the reduction in the amount of the water-soluble component by suitable hydrophobation of particles, the content of the structural unit derived from an aromatic group-containing (meth)acrylate is preferably 15% by mass to 90% by mass, more preferably 15% by mass to 80% by mass, and even more preferably 25% by mass to 70% by mass.

The self-dispersible polymer particles can be formed for example into a structure having other structural units, if necessary, in addition to the structural unit derived from an aromatic group-containing monomer and the structural unit derived from a dissociable group-containing monomer.

Monomers that form the other structural units are not particularly limited as long as they are monomers copolymerizable with the aromatic group-containing monomer and the dissociable group-containing monomer, and from the viewpoints of the flexibility of the polymer skeleton and the ease of control of glass transition temperature (Tg), alkyl group-containing monomers are preferable.

The alkyl group-containing monomer includes, for example, (meth)acrylates including alkyl(meth)acrylates such as methyl(meth)acrylate, ethyl(meth)acrylate, isopropyl(meth)acrylate, n-propyl(meth)acrylate, n-butyl(meth)acrylate, isobutyl(meth)acrylate, tert-butyl(meth)acrylate, hexyl(meth)acrylate, and ethylhexyl(meth)acrylate; ethylenically unsaturated monomers having a hydroxy group such as hydroxymethyl(meth)acrylate, 2-hydroxyethyl(meth)acrylate, 2-hydroxypropyl(meth)acrylate, 4-hydroxybutyl(meth)acrylate, hydroxypentyl(meth)acrylate, hydroxyhexyl(meth)acrylate; and dialkylaminoalkyl(meth)acrylates such as N,N-dimethylaminoethyl(meth)acrylate; and (meth)acrylamides including N-hydroxyalkyl(meth)acrylamides such as N-hydroxymethyl(meth)acrylamide, N-hydroxyethyl(meth)acrylamide, and N-hydroxybutyl(meth)acrylamide; and N-alkoxyalkyl(meth)acrylamides such as N-methoxymethyl(meth)acrylamide, N-ethoxymethyl(meth)acrylamide, N-n-butoxymethyl(meth)acrylamide, N-iso-butoxymethyl(meth)acrylamide, N-methoxyethyl(meth)acrylamide, N-ethoxyethyl(meth)acrylamide, N-n-butoxyethyl(meth)acrylamide, and N-iso-butoxyethyl(meth)acrylamide.

Specific examples (Exemplary Compounds B-01 to B-19) of the water-insoluble polymer constituting the self-dispersible polymer particles will be shown below. However, the invention is not limited thereto. The mass ratio of copolymer components is shown in parentheses.
B-01: Phenoxyethyl acrylate/methyl methacrylate/acrylic acid copolymer (45/50/5)
B-02: Phenoxyethyl acrylate/benzyl methacrylate/isobutyl methacrylate/methacrylic acid copolymer (30/35/29/6)
B-03: Phenoxyethyl methacrylate/isobutyl methacrylate/methacrylic acid copolymer (50/44/6)
B-04: Phenoxyethyl acrylate/methyl methacrylate/ethyl acrylate/acrylic acid copolymer (30/55/10/5)
B-05: Benzyl methacrylate/isobutyl methacrylate/methacrylic acid copolymer (35/59/6)
B-06: Styrene/phenoxyethyl acrylate/methyl methacrylate/acrylic acid copolymer (10/50/35/5)
B-07: Benzyl acrylate/methyl methacrylate/acrylic acid copolymer (55/40/5)
B-08: Phenoxyethyl methacrylate/benzyl acrylate/methacrylic acid copolymer (45/47/8)
B-09: Styrene/phenoxyethyl acrylate/butyl methacrylate/acrylic acid copolymer (5/48/40/7)
B-10: Benzyl methacrylate/isobutyl methacrylate/cyclohexyl methacrylate/methacrylic acid copolymer (35/30/30/5)
B-11: Phenoxyethyl acrylate/methyl methacrylate/butyl acrylate/methacrylic acid copolymer (12/50/30/8)
B-12: Benzyl acrylate/isobutyl methacrylate/acrylic acid copolymer (93/2/5)
B-13: Styrene/phenoxyethyl methacrylate/butyl acrylate/acrylic acid copolymer (50/5/20/25)
B-14: Styrene/butyl acrylate/acrylic acid copolymer (62/35/3)
B-15: Methyl methacrylate/phenoxyethyl acrylate/acrylic acid copolymer (45/51/4)
B-16: Methyl methacrylate/phenoxyethyl acrylate/acrylic acid copolymer (45/49/6)
B-17: Methyl methacrylate/phenoxyethyl acrylate/acrylic acid copolymer (45/48/7)
B-18: Methyl methacrylate/phenoxyethyl acrylate/acrylic acid copolymer (45/47/8)
B-19: Methyl methacrylate/phenoxyethyl acrylate/acrylic acid copolymer (45/45/10).

The molecular weight of the water-insoluble polymer constituting the self-dispersible polymer particles in the invention, in terms of weight-average molecular weight, is preferably 3,000 to 200,000, more preferably 5,000 to 150,000, and even more preferably 10,000 to 100,000. When the weight-average molecular weight is 3,000 or more, the amount of the water-soluble component can be effectively reduced. When the weight-average molecular weight is 200,000 or less, self-dispersion stability can be enhanced.

The weight-average molecular weight is measured by gel permeation chromatography (GPC). The GPC is carried out using HLC-8020 GPC (manufactured by Tosoh Corporation), with columns of TSKgel GMHxL, TSKgel G4000HxL, and TSKgel G2000HxL (trade name: all manufactured by Tosoh Corporation), and THF (tetrahydrofuran) as the eluent. The sample concentration is 0.35% by mass, the flow rate is 0.35 mL/min, the sample injection amount is 10 tL, the measurement temperature is 40° C., and an IR detector is used. The calibration curve is prepared using eight samples “standard sample TSK standard, polystyrene”: “F-40”, “IF-20”, “IF-4”, “IF-1”, “A-5000”, “A-2500”, “A-1000”, and “n-propyl benzene” manufactured by Tosoh Corporation.

From the viewpoint of regulating the hydrophilicity/hydrophobicity of the polymer, the water-insoluble polymer constituting the self-dispersible polymer particles is preferably a polymer which contains a structural unit derived from an aromatic group-containing (meth)acrylate in a copolymerization ratio of 15% by mass to 90% by mass with respect to the total mass of the self-dispersible polymer particles, a structural unit derived from a carboxy group-containing monomer, and a structural unit derived from an alkyl group-containing monomer, has an acid value of 25 to 100, and has a weight-average molecular weight of 3000 to 200,000, and more preferably a polymer which contains a structural unit derived from an aromatic group-containing (meth)acrylate (more preferably, a structural unit derived from a phenoxyethyl(meth)acrylate and/or a structural unit derived from a benzyl(meth)acrylate in a copolymerization ratio of 15% by mass to 80% by mass with respect to the total mass of the self-dispersible polymer particles, a structural unit derived from a carboxy group-containing monomer, and a structural unit derived from an alkyl group-containing monomer (more preferably a structural unit derived from a (meth)acrylic acid alkyl (preferably having 1 to 4 carbon atoms) ester), has an acid value of 25 to 95, and has a weight-average molecular weight of 5000 to 150,000.

The average particle diameter of the resin particles (particularly the self-dispersible polymer particles), in terms of volume-average particle diameter, is preferably in the range of 10 nm to 1 gm, more preferably in the range of 10 nm to 200 nm, even more preferably in the range of 20 nm to 100 nm, and further more preferably in the range of 20 nm to 50 nm. When the average particle diameter is 10 nm or more, manufacturing property is improved. When the average particle diameter is 1 μm or less, storage stability is improved. The particle-diameter distribution of the resin particles is not particularly limited, and the resin particles may be those having a broad particle-diameter distribution or those having a monodispersed particle-diameter distribution. A mixture of two or more types of water-insoluble particles may also be used.

The average particle diameter and particle-diameter dispersion of the resin particles are determined by measuring the volume-average particle diameter by a dynamic light scattering method with a Nanotrac particle size distribution measuring instrument UPA-EX 150 (manufactured by NIKKISO Co., Ltd.).

The glass transition temperature (Tg) of the resin particles (particularly the self-dispersible polymer particles) is preferably 30° C. or higher, more preferably 40° C. or higher, and even more preferably 50° C. or higher.

When the resin particles (particularly the self-dispersible polymer particles) are contained, the content thereof is preferably 0.5% by mass to 20% by mass, more preferably 3% by mass to 20% by mass, and even more preferably 5% by mass to 15% by mass, with respect to the total mass of the water based inkjet recording ink, from the viewpoint of image gloss etc.

—Surfactant—

The water based inkjet recording ink in the invention preferably contains at least one surfactant. The surfactant is used as a surface tension regulator. Examples of the surfactant include nonionic, cationic, anionic, and betaine surfactants.

In order to achieve good inkjetting in the inkjet methods, the surfactant is preferably used in an amount such that the the water based inkjet recording ink has a surface tension of 20 mN/m to 60 mN/m. Further, the surfactant is preferably used in an amount such that the surface tension is from 20 mN/m to 45 mN/m, and more preferably the surface tension is from 25 mN/m to 40 mN/m.

Examples of effective surfactants may include compounds containing hydrophilic and hydrophobic moieties in the molecule. The surfactant may also be anionic, cationic, ampholytic, or nonionic. Further the polymer substances (polymer dispersants) described above may be used as the surfactant.

Specific examples of the anionic surfactants include sodium dodecylbenzene sulfonate, sodium lauryl sulfate, sodium alkyl diphenyl ether disulfonate, sodium alkyl naphthalene sulfonate, sodium dialkyl sulfosuccinate, sodium stearate, potassium oleate, sodium dioctyl sulfosuccinate, sodium polyoxyethylene alkyl ether sulfate, sodium polyoxyethylene alkyl phenyl ether sulfate, sodium dialkyl sulfosuccinate, sodium stearate, sodium oleate, and sodium t-octylphenoxy ethoxypolyethoxyethyl sulfate. These anionic surfactancs may be used alone or in combination of two or more of them.

Specific examples of the nonionic surfactants include polyoxyethylene lauryl ether, polyoxyethylene octylphenyl ether, polyoxyethylene oleylphenyl ether, polyoxyethylene nonylphenyl ether, oxyethylene-oxypropylene block copolymer, t-octylphenoxyethyl polyethoxyethanol, and nonylphenoxyethyl polyethoxyethanol. These nonionic surfactants may be used alone or in a combination of two or more of them.

Examples of the cationic surfactants include tetraalkyl ammonium salts, alkylamine salts, benzalkonium salts, alkylpyridium salts, and imidazolium salts, and specific examples thereof include dihydroxyethylstearylamine, 2-heptadecenyl-hydroxyethylimidazoline, lauryldimethylbenzylammonium chloride, cetylpyridinium chloride, and stearamidomethylpyridinium chloride. These cationic surfactants may be used alone or in combination of two or more of them.

The content of the surfactant in the water based inkjet recording ink of the invention is not particularly limited, and is preferably 1% by mass or more, more preferably from 1% by mass to 10% by mass, and even more preferably 1% by mass to 3% by mass.

—Other Components—

The water based inkjet recording ink in the invention may contain, in addition to the above-described components, depending on needs, other components. Examples of the other components include a ultraviolet absorber, an anti-fading agent, a fungicide, a pH controlling agent, a rust preventive agent, an antioxidant, an emulsification stabilizer, a preservative, an anti-foaming agent, a viscosity regulator, a dispersion stabilizer, and a chelating agent.

Storage stability of an image formed by using the water based inkj et recording ink may be improved by including a ultraviolet absorber in the inkjet recording ink. Examples of the ultraviolet absorber include benzophenone ultraviolet absorbers, benzotriazole ultraviolet absorbers, salicylate ultraviolet absorbers, cyanoacrylate ultraviolet absorbers, and nickel complex salt ultraviolet absorbers.

Storage stability of an image formed by using the water based inkj et recording ink may be improved by including the anti-fading agent in the inkjet recording ink. The anti-fading agent may be selected from various organic and metal complex anti-fading agents. Examples of the organic anti-fading agents include hydroquinones, alkoxy phenols, dialkoxy phenols, phenols, anilines, amines, indans, chromanes, alkoxy anilines, and heterocycles. Examples of the metal complexes include nickel complexes and zinc complexes.

Examples of the fungicide include sodium dehydroacetate, sodium benzoate, sodium pyridinethiol-1-oxide, p-hydroxybenzoic acid ethyl ester, 1,2-benzisothiazolin-3-one, sodium sorbate, and sodium pentachlorophenolate. The content of the fungicide in ink is preferably from 0.02% by mass to 1.00% by mass.

The pH controlling agent is not specifically limited as long as it does not have an adverse effect on ink to be produced and can adjust the pH to a desired value. It can be appropriately selected according to the purpose of use.

Examples of the pH controlling agent include alcohol amines (for example, diethanolamine, triethanolamine, 2-amino-2-ethyl-1,3-propanediol and the like), hydroxides of an alkali metal (for example, lithium hydroxide, sodium hydroxide, potassium hydroxide and the like), ammonium hydroxides (for example, ammonium hydroxide and quaternary ammonium hydroxide), phosphonium hydroxides, alkali metal carbonates and the like.

Examples of the rust preventive agent include acidic sulfites, sodium thiosulfate, ammonium thioglycolate, diisopropyl-ammonium nitrite, pentaerythritol tetranitrate, and dicyclohexylammonium nitrite.

Examples of the antioxidant include phenol antioxidants (including hindered phenol antioxidants), amine antioxidants, sulfur containing antioxidants, and phosphorus containing antioxidants.

Examples of the chelating agent include sodium ethylenediamine tetraacetate, sodium nitrilotriacetate, sodium hydroxyethyl-ethylenediamine triacetate, sodium diethylenetriamine pentaacetate, and sodium uramildiacetate.

—Physical Properties of Ink—

The water based inkjet recording ink of the invention preferably has a viscosity (at 20° C.) of 1.2 mPa·s or more but less than 15.0 mPa·s, more preferably 2 mPa·s or more but less than 13 mPa·s, and even more preferably 2.5 mPa·s or more but less than 10 mPa·s, from the viewpoints of jetting stability when the water based inkjet recording ink is jetted by an inkjet method, and coagulating rate the liquid composition described below is used.

The viscosity is measured at 20° C. using VISCOMETER TV-22 (trade name, manufactured by Toki Sangyo Co., Ltd.).

The surface tension (25° C.) of the water based inkjet recording ink in the invention is preferably from 20 mN/m to 60 mN/m, more preferably from 20 mN/m to 45 mN/m, and even more preferably from 25 mN/m to 40 mN/m.

The surface tension is measured at 25° C. using an automatic surface tensiometer (trade name: CBVP-Z, manufactured by Kyowa Interface Science Co., Ltd.).

<<Liquid Composition>>

The water based inkjet recording ink of the invention described above is used preferably as a two-part aggregating ink including a liquid composition for improving printability. This liquid composition contains at least one aggregating component which upon contacting with the water based inkjet recording ink (also referred to hereinafter as simply “ink”) can form aggregates of the ink. This liquid composition may be added to the water based inkj et recording ink either before or after application onto a recording medium.

In the invention, it is a preferable embodiment that after application of the liquid composition, the water based inkjet recording ink is applied by ink-jetting. That is, it is a preferable embodiment that the liquid composition (particularly a liquid composition for aggregating the pigment or resin particles in the water based inkjet recording ink) is previously applied onto a recording medium before being coated with the water based inkjet recording ink, and then the water based inkjet recording ink is applied so as to contact with the liquid composition which has applied onto the recording medium, thereby forming an image. By so doing, the speed of inkjet recording can be increased and an image of high density and high resolution can be obtained even by high-speed recording.

Examples of the liquid composition include a liquid which may form aggregation by changing the pH of the ink. In this case, the pH of the liquid composition (25° C.) is preferably from 1 to 6, more preferably from 2 to 5 and even more preferably from 3 to 5. In this case, the pH of the water based inkjet recording ink (25° C.) is preferably 7.5 or more, and more preferably 8 or more.

In the invention, from the viewpoints of image density, resolution, and speedup of inkjet recording, it is particularly preferable that the pH of the water based inkjet recording ink (25° C.) be 7.5 or more, and the pH of the liquid composition (25° C.) be from 3 to 5.

The aggregating component for changing the pH of the ink includes acidic compounds. The acidic compound may be appropriately selected from polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrolecarboxylic acid, furancarboxylic acid, pyridinecarboxylic acid, coumalic acid, thiophenecarboxylic acid, nicotinic acid, derivatives of these compounds, and salts thereof. Among them, di- or higher basic acids are preferable. These acidic compounds may be used alone or in a combination of two or more of them.

In the case where the liquid includes the acidic compound, the content of the acidic compound is preferably from 5% by mass to 95% by mass, and more preferably from 10% by mass to 80% by mass with respect to the total mass of the liquid composition from the viewpoint of aggregation efficiency.

The liquid composition may be constituted by comprising, in addition to the acidic compound, a water-based solvent such as water.

Preferable examples of the liquid composition which enable immediate aggregation of the ink include a processing liquid containing a salt of a multivalent metal, polyallylamine or a derivative thereof.

Examples of the multivalent metal salts may include salts of alkaline earth metals belonging to group 2 of the periodic table (for example, magnesium and calcium), salts of transition metals belonging to group 3 of the periodic table (for example, lanthanum), cations of group 13 in the periodic table (for example, aluminum), and salts of lanthanides (for example, neodymium). Among these metal salts, carboxylates (for example, formates, acetates, and benzoates), nitrates, chlorides, and thiocyanates are preferable. Among them, calcium or magnesium salts of carboxylic acid (for example, formates, acetates, and benzoates), calcium or magnesium salts of nitric acid, calcium chloride, magnesium chloride, and calcium or magnesium salts of thiocyanic acid are particularly preferable.

A content of the metal salt in the liquid composition is preferably from 1% by mass toI 0% by mass, more preferably from 1.5% by mass to 7% by mass, and even more preferably from 2% by mass to 6% by mass.

The liquid composition preferably has a viscosity (at 20° C.) of from 1 mPa·s to 30 mPa·s, more preferably from 1 mPa·s to 20 mPa·s, even more preferably from 2 mPa·s to 15 mPa·s, and particularly preferably from 2 mPa·s to 10 mPa·s, from the viewpoint of coagulating rate of the water based inkjet recording ink.

The viscosity is measured at 20° C. using VISCOMETER TV-22 (trade name, manufactured by Toki Sangyo Co., Ltd.).

The surface tension (25° C.) of the liquid composition in the invention is preferably from 20 mN/m to 60 mN/m, more preferably from 20 mN/m to 45 mN/m, and even more preferably from 25 mN/m to 40 mN/m, from the viewpoint of coagulating rate of the water based inkjet recording ink.

The surface tension is measured at 25° C. using an automatic surface tensiometer (trade name: CBVP-Z, manufactured by Kyowa Interface Science Co., Ltd.).

<Inkjet Recording Method>

The water based inkjet recording ink of the invention can be used for image recording using the inkjet method.

More specifically, the image recording is performed by applying energy to the ink and thereby ejecting the ink onto a recording medium, such as plain paper, resin coated paper, inkjet recording paper described in, for example JP-A Nos. 8-169172, 8-27693, 2-276670, 7-276789, 9-323475, 62-238783, 10-153989, 10-217473, 10-235995, 10-217597, and 10-337947, film, electrophotographic paper, cloth, glass, metal, or ceramic to form a color image. The method described in the paragraphs 0093 to 0105 in JP-A No. 2003-306623 may be applied as a preferable inkjet recording method in the invention.

When the liquid composition is used along with the water based inkjet recording ink, the liquid composition may be applied by an arbitrary method selected from an inkjet method for ejection, a spray coating method, a roller coating method, a dipping method, etc. Particularly, the inkjet method is preferable from the viewpoint of selective formability on a region onto which the ink is ejected.

In the formation of an image, a polymer latex compound may also be used in combination to impart glossiness and water resistance, and to improve weather resistance. The polymer latex compound may be applied to the recording medium before, after, or at the same time of the application of the color materials. Therefore, the polymer latex compound may be applied to the recording medium, or contained in the ink, or used in another liquid state prepared with the polymer latex alone.

Specific examples thereof may include those described in JP-A Nos. 2002-166638, 2002-121440, 2002-154201, 2002-144696, and 2002-080759.

The inkjet method is not particularly limited, and may use a known system such as a charge controlling system of jetting ink using electrostatic attraction, a drop on demand system (pressure pulse system) of using vibratory pressure of piezo elements, an acoustic inkjet system of jetting ink using the radiation pressure of the ink caused by acoustic beam converted from an electric signal, and a thermal inkjet (Bubble Jet (registered trademark)) system of using a pressure generated by bubbles formed in the ink by heating. The inkjet method described in JP-A No. 54-59936 may be effectively used in which heat energy is applied to an ink to thereby abruptly change the ink volume, and the force exerted by the volume change makes the ink ejected from a nozzle.

Other examples of the inkjet method include a system of jetting many droplets of a low concentration ink, which is referred to as photo ink, at a small volume, a system of improving the image quality using a plurality of inks having substantially the same hue and different concentrations, and a system of using a colorless and transparent ink.

The inkjet heads used in the inkjet method may be of on-demand or continuous type. Specific examples of the ejection system may include, but not limited to, an electromechanical conversion system (for example, single cavity type, double cavity type, bender type, piston type, share mode type, and shared wall type), electrothermal conversion system (for example, thermal inkjet type and Bubble Jet (registered trademark) type), electrostatic suction system (for example, electric field control type and slit jet type), and electrical discharge system (for example, spark jet type).

The ink nozzle and the like used for the inkj et recording are not particularly limited, and may be appropriately selected according to the purpose.

One example of the image recording method preferably used in the invention is a method including:

Step 1: applying a liquid composition for improving printability onto a recording medium; and

Step 2: applying a water based inkj et recording ink onto the recording medium onto which the liquid composition has been applied.

This method may further comprise other steps such as a step of removal by drying, a step of fixation by heating, etc. The other steps are not particularly limited and can be selected appropriately depending on the purpose.

The step of removal by drying may be selected appropriately depending on the purpose and is not particularly limited as long as the ink solvent in the ink applied onto a recording medium can be removed by drying. The step of fixation by heating may be selected appropriately depending on the purpose and is not particularly limited as long as the resin particles (latex) and polymer component contained in the ink can be melt-fixed.

Another example of the image forming method in the invention is a method comprising:

Step 1: applying a liquid composition onto an intermediate transfer medium for use as a recording medium on which an image is to be first formed;

Step 2: applying a water based inkjet recording ink onto the intermediate transfer medium on which the liquid composition has been applied, thereby allowing the ink to form an image; and

Step 3: transferring the ink image formed on the intermediate transfer medium onto a recording medium.

This method, similar to the method described above, may further include other steps such as a step of removal by drying, a step of fixation by heating.

### EXAMPLES

The invention is further described with reference to the following examples, but the invention is not limited thereto. Unless otherwise noted, “part” indicates part by mass.

The weight-average molecular weight was measured by gel permeation chromatography (GPC). The GPC is carried out using HLC-8020 GPC (trade name, manufactured by Tosoh Corporation), with columns of TSKgel GMHxL, TSKgel G4000HxL, and TSKgel G2000HxL (trade name: all manufactured by Tosoh Corporation), and THF (tetrahydrofuran) as the eluent. The sample concentration was 0.35% by mass, the flow rate was 0.35 mL/min, the sample injection amount was 10 μL, the measurement temperature was 40° C., and an IR detector was used. The calibration curve was prepared using eight samples “standard sample TSK standard, polystyrene”: “F-40”, “F-20”, “F-4”, “F-1”, “A-5000”, “A-2500”, “A-1000”, and “n-propyl benzene” manufactured by Tosoh Corporation.

### Example 1

### (Synthesis of Polyvinyl Polymer)

Components in the monomer composition below were mixed with one another such that the total amount of the resulting mixture reached 100 parts, and then 1 part of 2,2′-azobis(2,4-dimethylvaleronitrile) was added thereto as a polymerization initiator followed by sufficiently substituting the atmosphere in the reaction system with a nitrogen gas, thereby obtaining a mixed solution.

### <Monomer Composition>

Methacrylate having an aromatic ring shown in Table 1 below [(meth)acrylate having an aromatic ring bonded via a linking group to the main chain thereof]: the amount shown in Table 1 below.
Methyl methacrylate: the amount shown in Table 1.
Methacrylic acid: the amount shown in Table 1.
2-Mercaptoethanol: 0.1 parts.

Then, 100 parts of methyl ethyl ketone were heated to 75° C. under stirring in a nitrogen atmosphere. The above mixed solution was added dropwise thereto at 75° C. over 3 hours under stirring. The mixture was further reacted at 75° C. under stirring for 5 hours. Thereafter, the reaction product was naturally cooled to 25° C. and then diluted with methyl ethyl ketone such that its sold content was reduced to 50% by mass, whereby a polyvinyl polymer solution was obtained.

The weight-average molecular weight of each polyvinyl polymer thus synthesized is shown in Table 1 below.

(Preparation of an Aqueous Dispersion of Pigment-Containing Polyvinyl Polymer Particles)

Neutralized were 10 parts of the resulting polyvinyl polymer solution with a 5 mol/L aqueous solution of sodium hydroxide. In this process, the alkali was added in an amount to completely neutralize methacrylic acid or acrylic acid of the polyvinyl polymer. Subsequently, 10 parts of a pigment shown in Table 1 (C.I. Pigment Yellow 155 manufactured by Clariant (Japan) K.K. or C.I. Pigment Yellow 74 manufactured by Dainichiseika Colour & Chemicals Mfg. Co., Ltd.) were added thereto, and the mixture was kneaded with a roll mill for 2 hours to 8 hours as necessary. The kneaded material was dispersed in 100 parts of ion-exchanged water. The resulting dispersion was concentrated by removing the organic solvent completely at 55° C. under reduced pressure and further by removing the water, thereby yielding an aqueous dispersion containing pigment-containing polyvinyl polymer particles in a solid content of 15% by mass.

(Preparation of an Aqueous Dispersion of Self-Dispersible Polymer Fine Particles)

350.0 g of methyl ethyl ketone was placed into a 2L three-neck flask equipped with a stirrer, a thermometer, a reflex condenser tube and a nitrogen gas inlet tube, and then heated to 75° C. While the temperature in the reaction container was kept at 75° C., a mixed solution consisting of 162.0 g of phenoxyethyl acrylate, 180.0 g of methyl methacrylate, 18.0 g of acrylic acid, 70 g of methyl ethyl ketone and 1.44 g of V-601 (trade name, manufactured by Wako Pure Chemical Industries, Ltd.) was dropped into the flask at a constant rate such that the dropping was finished for 2 hours. After completion of the dropping, a solution consisting of 0.72 g of V-601 and 36.0 g of methyl ethyl ketone was added thereto, the reaction solution was then stirred at 75° C. for 2 hours, and a solution consisting of 0.72 g of V-601 and 36.0 g of isopropanol was further added to the reaction solution which was further stirred at 75° C. for 2 hours. Thereafter, the reaction solution was heated to 85° C. and stirred for additional 2 hours to obtain a copolymer solution.

The weight-average molecular weight (Mw) of the copolymer thus obtained was 64000 (polystyrene-equivalent molecular weight determined by GPC), and the acid value thereof as determined by a method described in JIS (Japanese Industrial Standard) (JISK0070: 1992) was 38.9 (mg KOH/g).

Then, 668.3 g of the resultant copolymer solution was weighed out, then 388.3 g of isopropanol and 145.7 mL of a 1 mol/L aqueous solution of NaOH were added thereto, and the temperature in the reaction container was elevated to 80° C. Then, 720.1 g of distilled water was added dropwise to the reaction solution at a rate of 20 mL/min to form an aqueous dispersion. Thereafter, the temperature in the reaction container was kept at 80° C. for 2 hours, at 85° C. for 2 hours and at 90° C. for 2 hours, at atmospheric pressure, and then the reaction container was depressurized, whereby the isopropanol, methyl ethyl ketone and distilled water, in a total amount of 913.7 g, were distilled away, thereby yielding an aqueous dispersion (emulsion) containing self-dispersible polymer fine particles (B-01) in a solid content of 28.0%.

(Preparation of Water Based Inks)

Components in the following composition were mixed to prepare water based inks shown in Table 1 below (inks 101 to 150). When the prepared water based inks were measured for their pH with a pH meter WM-50EG (manufactured by DKK-TOA CORPORATION), every water based ink had pH 8.5 (25° C.).

<Composition>

| | | |
|---|---|---|
| Aqueous dispersion of the pigment-containing polyvinyl | 30 | parts |
| polymer particles (see Table 1) | | |
| Glycerin | 5 | parts |
| Diethylene glycol | 5 | parts |
| Triethylene glycol monobutyl ether | 5 | parts |
| Polyoxypropylene glyceryl ether | 5 | parts |
| Dipropylene glycol | 5 | parts |
| Triethanolamine | 1 | part |
| OLEFIN E1010 (trade name, manufactured by Nisshin | 1 | part |
| Chemicals Co., Ltd.) | | |
| Aqueous dispersion of the self-dispersible polymer fine | 15 | parts |
| particles (B-01) | | |
| Ion-exchanged water | 28 | parts |

(Image Recording and Evaluation)

The water based inks (inks 101 to 150) obtained as described above were used in recording images and evaluated for their discharge accuracy. The evaluation results are shown in Table 1.

Each of the resultant inks 101 to 150 was placed in (a) a polyethylene terephthalate (PET) container, sealed, and stored in an environment at 62° C. for 2 weeks or placed in (b) a high-density polyethylene container, sealed, and stored at room temperature for 5 months. After storage for the predetermined period, each ink was taken out, then charged into an inkjet recording apparatus (trade name: PRINTER DMP-2831, manufactured by FUJIFILM Dimatix, Inc.) and subjected to 10 cm-line printing with an ink liquid droplet in a volume of 2 pL at a discharge frequency of 20 kHz at 16×1200 dpi in the nozzle array direction x delivery direction. The recording medium used herein was (trade name: Kassai-Shashin shiage Pro (Premium Plus Photo Paper Professional), manufactured by Fuji Film Corporation).

The distance between lines in a 5 cm-region from the initiation site of dotting with droplets on the obtained printed sample was measured with a dot analyzer DA-6000 (trade name, manufactured by Oji Scientific Instruments), and the standard deviation was calculated. From the obtained value, the discharge direction accuracy was evaluated under the following evaluation criteria.

### <Evaluation Criteria>

AA: The standard deviation is less than 3 μm.
A: The standard deviation is 3 μm or more and less than 4 μm.
B: The standard deviation is 4 μm or more and less than 5 μm.
C: The standard deviation is 5 μm or more.

TABLE 1

| | | | | | | Mass of | | |
|---|---|---|---|---|---|---|---|---|
| | | Composition of Polyvinyl Polymer | | | | polyvinyl | | |
| | | | | | Weight- | polymer | | |
| | | Methacrylate (*1) having | Methacrylic | Methyl | average | (relative | Discharge | |
| | | an aromatic ring | acid | methacrylate | molecular | to pigment) | accuracy | |
| No. | Pigment | [mass %] | [mass %] | [mass %] | weight | (%) | (*2) | Remark |
| Ink 101 | C.I. Pigment Yellow 155 | benzyl methacrylate = 55 | 3 | 42 | 44000 | 50 | C | Comp. (*3) |
| Ink 102 | C.I. Pigment Yellow 155 | benzyl methacrylate = 55 | 5 | 40 | 41000 | 50 | A | The Invention |
| Ink 103 | C.I. Pigment Yellow 155 | benzyl methacrylate = 55 | 7 | 38 | 47000 | 50 | AA | The Invention |
| Ink 104 | C.I. Pigment Yellow 155 | benzyl methacrylate = 55 | 12 | 33 | 42000 | 50 | AA | The Invention |
| Ink 105 | C.I. Pigment Yellow 155 | benzyl methacrylate = 55 | 15 | 30 | 43000 | 50 | AA | The Invention |
| Ink 106 | C.I. Pigment Yellow 155 | benzyl methacrylate = 55 | 18 | 27 | 40000 | 50 | A | The Invention |
| Ink 107 | C.I. Pigment Yellow 155 | benzyl methacrylate = 55 | 20 | 25 | 49000 | 50 | C | Comp. (*3) |
| Ink 108 | C.I. Pigment Yellow 155 | benzyl methacrylate = 55 | 40 | 5 | 43000 | 50 | C | Comp. (*3) |
| Ink 109 | C.I. Pigment Yellow 155 | benzyl methacrylate = 67 | 33 | 0 | 41000 | 50 | C | Comp. (*3) |
| Ink 110 | C.I. Pigment Yellow 155 | benzyl methacrylate = 67 | 33 | 0 | 12000 | 50 | C | Comp. (*3) |
| Ink 111 | C.I. Pigment Yellow 74 | benzyl methacrylate = 55 | 3 | 42 | 44000 | 50 | B | Comp. (*3) |
| Ink 112 | C.I. Pigment Yellow 74 | benzyl methacrylate = 55 | 5 | 40 | 41000 | 50 | B | Comp. (*3) |
| Ink 113 | C.I. Pigment Yellow 74 | benzyl methacrylate = 55 | 7 | 38 | 47000 | 50 | B | Comp. (*3) |
| Ink 114 | C.I. Pigment Yellow 74 | benzyl methacrylate = 55 | 12 | 33 | 42000 | 50 | B | Comp. (*3) |
| Ink 115 | C.I. Pigment Yellow 74 | benzyl methacrylate = 55 | 15 | 30 | 43000 | 50 | B | Comp. (*3) |
| Ink 116 | C.I. Pigment Yellow 74 | benzyl methacrylate = 55 | 18 | 27 | 40000 | 50 | B | Comp. (*3) |
| Ink 117 | C.I. Pigment Yellow 74 | benzyl methacrylate = 55 | 20 | 25 | 49000 | 50 | C | Comp. (*3) |
| Ink 118 | C.I. Pigment Yellow 74 | benzyl methacrylate = 55 | 30 | 15 | 44000 | 50 | C | Comp. (*3) |
| Ink 119 | C.I. Pigment Yellow 155 | phenoxyethyl methacrylate = | 3 | 42 | 41000 | 50 | B | Comp. (*3) |
| | | 55 | | | | | | |
| Ink 120 | C.I. Pigment Yellow 155 | phenoxyethyl methacrylate = | 5 | 40 | 40000 | 50 | AA | The Invention |
| | | 55 | | | | | | |
| Ink 121 | C.I. Pigment Yellow 155 | phenoxyethyl methacrylate = | 7 | 38 | 46000 | 50 | AA | The Invention |
| | | 55 | | | | | | |
| Ink 122 | C.I. Pigment Yellow 155 | phenoxyethyl methacrylate = | 12 | 33 | 47000 | 50 | AA | The Invention |
| | | 55 | | | | | | |
| Ink 123 | C.I. Pigment Yellow 155 | phenoxyethyl methacrylate = | 15 | 30 | 45000 | 50 | AA | The Invention |
| | | 55 | | | | | | |
| Ink 124 | C.I. Pigment Yellow 155 | phenoxyethyl methacrylate = | 18 | 27 | 43000 | 50 | A | The Invention |
| | | 55 | | | | | | |
| Ink 125 | C.I. Pigment Yellow 155 | phenoxyethyl methacrylate = | 20 | 25 | 49000 | 50 | C | Comp. (*3) |
| | | 55 | | | | | | |
| Ink 126 | C.I. Pigment Yellow 155 | phenoxyethyl methacrylate = | 30 | 15 | 46000 | 50 | C | Comp. (*3) |
| | | 55 | | | | | | |
| Ink 127 | C.I. Pigment Yellow 155 | styrene = 55 | 3 | 42 | 41000 | 50 | C | Comp. (*3) |
| Ink 128 | C.I. Pigment Yellow 155 | styrene = 55 | 5 | 40 | 43000 | 50 | C | Comp. (*3) |
| Ink 129 | C.I. Pigment Yellow 155 | styrene = 55 | 7 | 38 | 49000 | 50 | C | Comp. (*3) |
| Ink 130 | C.I. Pigment Yellow 155 | styrene = 55 | 12 | 33 | 42000 | 50 | C | Comp. (*3) |
| Ink 131 | C.I. Pigment Yellow 155 | styrene = 55 | 15 | 30 | 48000 | 50 | C | Comp. (*3) |
| Ink 132 | C.I. Pigment Yellow 155 | styrene = 55 | 18 | 27 | 44000 | 50 | C | Comp. (*3) |
| Ink 133 | C.I. Pigment Yellow 155 | styrene = 55 | 20 | 25 | 47000 | 50 | C | Comp. (*3) |
| Ink 134 | C.I. Pigment Yellow 155 | styrene = 55 | 30 | 15 | 43000 | 50 | C | Comp. (*3) |
| Ink 135 | C.I. Pigment Yellow 155 | none | 12 | 88 | 44000 | 50 | C | Comp. (*3) |
| Ink 136 | C.I. Pigment Yellow 155 | benzyl methacrylate = 5 | 12 | 83 | 41000 | 50 | A | The Invention |
| Ink 137 | C.I. Pigment Yellow 155 | benzyl methacrylate = 20 | 12 | 68 | 43000 | 50 | AA | The Invention |
| Ink 138 | C.I. Pigment Yellow 155 | benzyl methacrylate = 40 | 12 | 48 | 48000 | 50 | AA | The Invention |
| Ink 139 | C.I. Pigment Yellow 155 | benzyl methacrylate = 60 | 12 | 28 | 42000 | 50 | AA | The Invention |
| Ink 140 | C.I. Pigment Yellow 155 | Benzyl methacrylate = 80 | 12 | 8 | 44000 | 50 | A | The Invention |
| Ink 141 | C.I. Pigment Yellow 155 | benzyl methacrylate = 55 | 12 | 33 | 42000 | 20 | A | The Invention |
| Ink 142 | C.I. Pigment Yellow 155 | benzyl methacrylate = 55 | 12 | 33 | 42000 | 30 | AA | The Invention |
| Ink 143 | C.I. Pigment Yellow 155 | benzyl methacrylate = 55 | 12 | 33 | 42000 | 50 | AA | The Invention |
| Ink 144 | C.I. Pigment Yellow 155 | benzyl methacrylate = 55 | 12 | 33 | 42000 | 60 | AA | The Invention |
| Ink 145 | C.I. Pigment Yellow 155 | benzyl methacrylate = 55 | 12 | 33 | 42000 | 70 | A | The Invention |
| Ink 146 | C.I. Pigment Yellow 155 | benzyl methacrylate = 55 | 12 | 33 | 25000 | 50 | A | The Invention |
| Ink 147 | C.I. Pigment Yellow 155 | benzyl methacrylate = 55 | 12 | 33 | 30000 | 50 | AA | The Invention |
| Ink 148 | C.I. Pigment Yellow 155 | benzyl methacrylate = 55 | 12 | 33 | 42000 | 50 | AA | The Invention |
| Ink 149 | C.I. Pigment Yellow 155 | benzyl methacrylate = 55 | 12 | 33 | 80000 | 50 | AA | The Invention |
| Ink 150 | C.I. Pigment Yellow 155 | benzyl methacrylate = 55 | 12 | 33 | 85000 | 50 | A | The Invention |

(*1): (Meth)acrylate having an aromatic ring bonded via a linking group to the main chain
(*2): Discharge accuracy shows results evaluated under both the conditions (a) and (b).
(*3): Comp = Comparative Example

Table 1 shows that when the inks 101 to 108 were evaluated for the dependency of discharge accuracy on the amount of methacrylic acid as the hydrophilic structural unit (b), in the case where polyvinyl polymer contains benzyl methacrylate (that is, “methacrylate having an aromatic ring bonded via a linking group to the main chain thereof”) as the hydrophobic structural unit (a) in the copolymerizable component and C. I. Pigment is used as the pigment, the inks containing the methacrylic acid-derived structural unit in a ratio (copolymerization ratio) of 5% by mass to 18% by mass were excellent in discharge accuracy even after storage under high-temperature conditions. It is further revealed that the ratio of the methacrylic acid-derived structural unit is more preferably 7% by mass to 15% by mass.

The ink 110 is an example wherein a polyvinyl polymer (PD-1) (benzyl methacrylate/methacrylic acid copolymer (=67/33 [mass ratio] with a number-average molecular weight of 5000, a weight-average molecular weight of 12000 and a neutralization degree of 67% by alkali) described in US Patent No. 2006-014855 was synthesized and used, and this ink was inferior in discharge accuracy.

Also, the ink 109 is an example wherein benzyl methacrylate/methacrylic acid copolymer (=67/33 [mass ratio] with a number-average molecular weight of 41000, a neutralization degree of 100% by alkali) was synthesized and used as a polyvinyl polymer, and this ink was inferior in discharge accuracy.

From the two inks, it can be seen that when the copolymer ratio of methacrylic acid is 33% by mass, good results cannot be obtained.

Then, the inks 111 to 118 were prepared in a manner substantially similar to that in the preparation of the inks 101 to 108 except that the pigment was changed to C.I. Pigment Yellow 74. When the discharge accuracy of the inks was evaluated, excellent discharge accuracy could not be obtained.

The inks 119 to 126 were prepared in a manner substantially similar to that in the preparation of the inks 101 to 108 except that benzyl methacrylate used as the monomer forming the hydrophobic structural unit (a) of the polyvinyl polymer was changed to phenoxyethyl methacrylate. Evaluation of the discharge accuracy of the inks revealed that when the ratio of the methacrylic acid-derived structural unit was 5% by mass to 18% by mass, the inks even after storage under high-temperature conditions were excellent in discharge accuracy.

The inks 127 to 134 were prepared in a manner substantially similar to that in the preparation of the inks 101 to 108 except that benzyl methacrylate used as the monomer forming the hydrophobic structural unit (a) of the polyvinyl polymer was changed to styrene having an aromatic ring bonded directly to the main chain. The inks were inferior in discharge accuracy.

When the inks 135 to 140 were evaluated for the dependency of discharge accuracy on the amount of benzyl methacrylate (that is, “methacrylate having an aromatic ring bonded via a linking group to the main chain”) in the polyvinyl polymer containing benzyl methacrylate as the hydrophobic structural unit (a) in the copolymerizable component, the ink 135 not using benzyl methacrylate was poor in discharge accuracy, and when the benzyl methacrylate-derived structural unit was in the range of 20% by mass to 60% by mass, the discharge accuracy was particularly excellent.

As shown in the inks 141 to 145, the inks wherein the content ratio of the pigment to the polyvinyl polymer was in the range of 30% to 60% were particularly excellent in discharge accuracy.

As shown in the inks 146 to 150, the inks wherein the weight-average molecular weight of the polyvinyl polymer was in the range of 30,000 to 80,000 were particularly excellent in discharge accuracy.

Not only under the condition (a) where the ink was placed in a PET container, sealed, and stored in an environment at 62° C. for 2 weeks, but also under the condition (b) where the ink was placed in a high-density polyethylene container, sealed, and stored at room temperature for 5 months, the same results are obtained.

### Example 2

Water based inks were prepared in a manner substantially similar to that in the preparation of the inks 101 to 108 in Example 1 except that methacrylic acid forming the hydrophilic structural unit (b) in the inks 101 to 108 was changed to acrylic acid, and the discharge accuracy of the resulting water based inks was evaluated.

The result indicated that when acrylic acid was used, the counterparts to the inks 101, 107 and 108 were poor in discharge accuracy, while the counterparts to the inks 102 to 106 showed excellent performance.

### Example 3

Water based inks were prepared in a manner substantially similar to that in the preparation of the inks 101 to 108 in Example 1 except that methyl methacrylate forming the hydrophobic structural unit (a) in the inks 101 to 108 was changed to methyl acrylate, ethyl acrylate, ethyl methacrylate, butyl methacrylate, 2-ethylhexyl methacrylate, cyclohexyl methacrylate, cyclohexyl acrylate, styrene, or a styrene macromer, and the discharge accuracy of the resulting water based inks was evaluated.

The result indicated that when methyl acrylate, ethyl acrylate, ethyl methacrylate, butyl methacrylate, 2-ethylhexyl methacrylate, cyclohexyl methacrylate, cyclohexyl acrylate, styrene, or a styrene macromer was used, the counterparts to the inks 101, 107 and 108 were poor in discharge accuracy, while the counterparts to the inks 102 to 106 showed excellent performance.

### Example 4

Water based inks (inks 201 to 250) were prepared in a manner substantially similar to that in the preparation of the inks 101 to 150 in Examples 1 to 3 except that the aqueous dispersion (15 parts) of the self-dispersible polymer fine particles (B-01) used in preparation of the water based inks (inks 101 to 150) was changed to 15 parts of ion-exchane water, and the discharge accuracy of the resulting water based inks was evaluated.

As a result, concerning the obtained inks 201 to 250, similar to the corresponding inks 101 to 150, the inks of the invention showed excellent performance.

### Example 5

Line printing was conducted in a manner substantially similar to that in Examples 1 to 4 except that the recording medium, “GRAPHIC COLORING/PHOTOGRAPHIC FINISHING PRO” (trade name, manufactured by FUJIFILM CORPORATION), was changed to “U-LIGHT” (trade name, manufactured by Nippon Paper Industries Co., Ltd.), “XEROX 4024” (trade name, manufactured by Fuji Xerox Co., Ltd.), “OK PRINCE JOSHITSU” (trade name, manufactured by Oji Paper Co., Ltd.), “SHIORAI” (trade name, manufactured by Nippon Paper Industries Co., Ltd.), “OK EVER LIGHT COAT” (trade name, manufactured by Oji Paper Co., Ltd.), “AURORA COAT” manufactured by Nippon Paper Industries Co., Ltd.), or “TOKUBISHI ART PAPER” (trade name, manufactured by Mitsubishi Paper Mills Limited). The discharge accuracy of each water based ink was evaluated.

As a result, it was confirmed that when the water based inks of the invention (see Table 1) were used, excellent performance similar to that in Examples 1 to 4 was obtained.

### Example 6

### (Preparation of Liquid Composition)

To constitute a two-part aggregating ink, components in the following composition were mixed to prepare a liquid composition for aggregating the ink. When the viscosity, surface tension and pH of the resulting liquid composition were measured, the viscosity (20° C.) was 4.7 mPa·s, the surface tension (25° C.) was 24.1 mN/m, and the pH (25° C.) was 1.6.

### <Composition of Liquid Composition>

Citric acid (manufactured by Wako Pure Chemical Industries, Ltd.): 15.0% by mass
Diethylene glycol monomethyl ether (manufactured by Wako Pure Chemical Industries, Ltd.): 20.0% by mass
ZONYL FSN-100 (manufactured by DuPont): 1.0% by mass
Ion-exchanged water: 64.0% by mass

The viscosity was measured with a VISCOMETER TV-22 (trade name, manufactured by Toki Sangyo Co., Ltd.), and the surface tension was measured with an automatic surface tensiometer (trade name: CBVP-Z, manufactured by Kyowa Interface Science Co., Ltd.). The pH was measured with a pH meter WM-50EG (trade name, manufactured by DKK-TOA CORPORATION).

(Image Recording and Evaluation)

The liquid composition obtained above was applied with a wire bar coater to a thickness of about 5 gm (amount of citric acid: 0.76 g/m²) onto the recording medium used in Examples 1 to 5. Thereafter, it was dried with drying air at 70° C. for 20 seconds. Immediately thereafter, the same water based ink as used in each of Examples 1 to 5 was used in dot printing and line printing with an ink liquid droplet in a volume of 2 pL at a discharge frequency of 20 kHz with an inkjet recording apparatus (trade name: PRINTER DMP-2831, manufactured by FUJIFILM Dimatix, Inc.). The discharge accuracy of each water based ink was evaluated.

As a result, it was confirmed that when the water based inks of the invention (see Table 1) are used, excellent performance similar to that in Examples 1 to 5 was obtained.

According to the invention, there can be provided a water based inkjet recording ink, which is excellent in discharge stability and capable of preventing generation of uneven density and streaked marks on the recorded image, even after storage for a long period of time or in a high-temperature environment. The present invention may namely provide the following items <1> to <13>:

<1> A water based inkjet recording ink including at least: polyvinyl polymer particles and an aqueous medium, the polyvinyl polymer particles containing: a polyvinyl polymer containing (a) a hydrophobic structural unit derived from at least one member selected from acrylates and methacrylates each having an aromatic ring bonded via a linking group to the main chain thereof, and (b) a hydrophilic structural unit derived from acrylic acid and/or methacrylic acid and contained in an amount of 5% by mass to 18% by mass with respect to the total mass of the polymer; and C.I. Pigment Yellow 155.

<2> The water based inkj et recording ink of the item <1>, wherein the hydrophobic structural unit (a) is a structural unit represented by the following Formula (I):

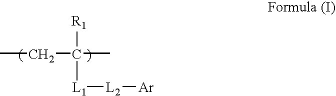

wherein in Formula (I), R₁ represents a hydrogen atom, a methyl group, or a halogen atom; L₁ represents *—COO—, *—OCO—, *—CONR₂—, *—O—, or a substituted or unsubstituted phenylene group; L₂ represents a single bond or a divalent linking group having 1 to 30 carbon atoms; Ar represents a monovalent group derived from an aromatic ring; R₂ represents a hydrogen atom or an alkyl group having 1 to 10 carbon atoms; and an asterisk (*) in the group represented by L₁ denotes a bond linking to the main chain.

<3> The water based inkjet recording ink of the item <2>, wherein, in Formula (I), R₁ represents a hydrogen atom or a methyl group; L₁ represents *—COO—; and L₂ represents a single bond or a divalent linking group having 1 to 25 carbon atoms and comprising an alkylene oxy group and/or an alkylene group.

<4> The water based inkj et recording ink of the item <1>, wherein a structural unit derived from phenoxyethyl(meth)acrylate and/or a structural unit derived from benzyl(meth)acrylate, in an amount of 20% by mass or more with respect to the total mass of the polyvinyl polymer, is contained as the hydrophobic structural unit (a).

<5> The water based inkj et recording ink of the item <1> or the item <4>, wherein a structural unit derived from phenoxyethyl(meth)acrylate, in an amount of 20% by mass or more with respect to the total mass of the polyvinyl polymer, is contained as the hydrophobic structural unit (a).

<6> The water based inkjet recording ink of any one of the items <1> to <5>, wherein the content ratio of the C.I. Pigment Yellow 155 to the polyvinyl polymer is 30% by mass to 60% by mass.

<7> The water based inkjet recording ink of any one of the items <1> to <6>, wherein the weight-average molecular weight of the polyvinyl polymer is 30,000 to 80,000.

<8> The water based inkjet recording ink of any one of the items <1> to <7>, which further comprises self-dispersible polymer particles.

<9> The water based inkjet recording ink of the item <8>, wherein the self-dispersible polymer particles have a carboxy group.

<10> The water based inkj et recording ink of the item <8> or the item <9>, wherein the self-dispersible polymer particles are particles of a polymer comprising a structural unit derived from an aromatic group-containing (meth)acrylate, in an amount of 15% by mass to 80% by mass with respect to the total mass of the self-dispersible polymer particles, and a structural unit derived from an alkyl group-containing monomer.

<11> The water based inkj et recording ink of the item <10>, wherein the aromatic group-containing (meth)acrylate is phenoxyethyl(meth)acrylate and/or benzyl(meth)acrylate.

<12> The water based inkjet recording ink of the item <10> or the item <11>, wherein the alkyl group-containing monomer is an alkyl(meth)acrylate in which the alkyl moiety has 1 to 4 carbon atoms.

<13> The water based inkjet recording ink of any one of the items <1> to <12>, which further comprises a surfactant.

The foregoing description of the exemplary embodiments of the present invention has been provided for the purposes of illustration and description. It is not intended to be exhaustive or to limit the invention to the precise forms disclosed. The embodiments were chosen and described in order to best explain the principles of the invention and its practical applications, thereby enabling others skilled in the art to understand the invention for various embodiments and with the various modifications as are suited to the particular use contemplated.

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

What is claimed is:

1. A water based inkjet recording ink, comprising polyvinyl polymer particles and an aqueous medium, the polyvinyl polymer particles containing:
a polyvinyl polymer containing (a) a hydrophobic structural unit derived from at least one member selected from acrylates and methacrylates each having an aromatic ring bonded via a linking group to the main chain thereof, and (b) a hydrophilic structural unit derived from acrylic acid and/or methacrylic acid and contained in an amount of 5% by mass to 18% by mass with respect to the total mass of the polymer; and
C.I. Pigment Yellow 155.

2. The water based inkj et recording ink of claim 1, wherein the hydrophobic structural unit (a) is a structural unit represented by the following Formula (I): 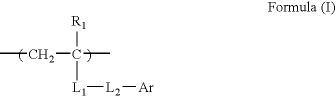
wherein in Formula (I), R₁ represents a hydrogen atom, a methyl group, or a halogen atom; L₁ represents *—COO—, *—OCO—, *—CONR₂—, *—O—, or a substituted or unsubstituted phenylene group; L₂ represents a single bond or a divalent linking group having 1 to 30 carbon atoms; Ar represents a monovalent group derived from an aromatic ring; R₂ represents a hydrogen atom or an alkyl group having 1 to 10 carbon atoms; and an asterisk (*) in the group represented by L₁ denotes a bond linking to the main chain.

3. The water based inkjet recording ink of claim 2, wherein, in Formula (I), R₁ represents a hydrogen atom or a methyl group; L₁ represents *—COO—; and L₂ represents a single bond or a divalent linking group having 1 to 25 carbon atoms and comprising an alkylene oxy group and/or an alkylene group.

4. The water based inkj et recording ink of claim 1, wherein a structural unit derived from phenoxyethyl(meth)acrylate and/or a structural unit derived from benzyl(meth)acrylate, in an amount of 20% by mass or more with respect to the total mass of the polyvinyl polymer, is contained as the hydrophobic structural unit (a).

5. The water based inkj et recording ink of claim 1, wherein a structural unit derived from phenoxyethyl(meth)acrylate, in an amount of 20% by mass or more with respect to the total mass of the polyvinyl polymer, is contained as the hydrophobic structural unit (a).

6. The water based inkjet recording ink of claim 1, wherein the content ratio of the C.I. Pigment Yellow 155 to the polyvinyl polymer is 30% by mass to 60% by mass.

7. The water based inkjet recording ink of claim 1, wherein the weight-average molecular weight of the polyvinyl polymer is 30,000 to 80,000.

8. The water based inkj et recording ink of claim 1, which further comprises self-dispersible polymer particles.

9. The water based inkjet recording ink of claim 8, wherein the self-dispersible polymer particles have a carboxy group.

10. The water based inkjet recording ink of claim 8, wherein the self-dispersible polymer particles are particles of polymer comprising a structural unit derived from an aromatic group-containing (meth)acrylate, in an amount of 15% by mass to 80% by mass with respect to the total mass of the self-dispersible polymer particles, and a structural unit derived from an alkyl group-containing monomer.

11. The water based inkjet recording ink of claim 10, wherein the aromatic group-containing (meth)acrylate is phenoxyethyl(meth)acrylate and/or benzyl(meth)acrylate.

12. The water based inkjet recording ink of claim 10, wherein the alkyl group-containing monomer is an alkyl(meth)acrylate in which the alkyl moiety has 1 to 4 carbon atoms.

13. The water based inkjet recording ink of claim 1, which further comprises a surfactant.
